(19) United States
(12) Patent Application Publication
(10) Pub. No.: US 2007/0156380 A1
(43) Pub. Date: Jul. 5, 2007

(54) Logic event simulation

(76) Inventor: Damian Dalton, Dublin (IE)

Correspondence Address: BIRCH STEWART KOLASCH & BIRCH, PO BOX 747, FALLS CHURCH, VA, 22040-0747, US

(21) Appl. No.: 11/699,015

(22) Filed: Jan. 29, 2007

Related U.S. Application Data
(63) Continuation of application No. 10/019,059, filed on Apr. 19, 2002, now abandoned.

(30) Foreign Application Priority Data
Jun. 28, 1999 (IE) S990535

(51) Int. Cl. G06F 17/50

(52) U.S. Cl. 703/15

(57) ABSTRACT

A parallel processor for a logic event simulation (APPLES) including a main processor and an associative memory mechanism including a response resolver. Further, the associative memory mechanism includes a plurality of separate associative sub-registers each for storing in word form of a history of gate input signals for a specified type of logic gate, and a plurality of separate additional sub-registers associated with each associative sub-register whereby gate evaluations and tests can be carried out in parallel on each associative sub-register.

### INTRODUCTION

The present invention is directed towards a parallel processing method of logic simulation comprising representing signals on a line over a time period as a bit sequence, evaluating the output of any logic gate including an evaluation of any inherent delay by a comparison between the bit sequences of its inputs to a predetermined series of bit patterns and in which those logic gates whose outputs have changed over the time period are identified during the evaluation of the gate outputs as real gate changes and only those real gate changes are propagated to fan out gates and in which the control of the method is carried out in an associative memory mechanism which stores in word form a history of gate input signals by compiling a hit list register of logic gate state changes and using a multiple response resolver forming part of the associative memory mechanism which generates an address for each hit, and then scans and transfers the results on the hit list to an output register for subsequent use. The output register may contain the final result of the simulation or may be a list of outputs to be used for subsequent fan out to other gates. Further, the invention is directed towards providing a parallel processor for logic event simulation (APPLES).

Logic simulation plays an important role in the design and validation of VLSI circuits. As circuits increase in size and complexity, there is an ever demanding requirement to accelerate the processing speed of this design tool. Parallel processing has been perceived in industry as the best method to achieve this goal and numerous parallel processing systems have been developed. Unfortunately, large speedup figures have eluded these approaches. Higher speedup figures have been achieved, but only by compromising the accuracy of the gate delay model employed in these systems. A large communication overhead due to basic passing of values between processors, elaborate measures to avoid or recover from deadlock and load balancing techniques, is the principal barrier.

The ever-expanding size of VLSI (Very Large Scale Integration) circuits has further emphasised the need for a fast and accurate means of simulating digital circuits. A compromise between model accuracy and computational feasibility is found in logic simulation. In this simulation paradigm, signal values are discrete and may acquire in the simplest case logic values 0 and 1. More complex transient state signal values are modelled using up to 9-state logic. Logic gates can be modelled as ideal components with zero switching time or more realistically as electronic components with finite delay and switching characteristics such as inertial, pure or ambiguous delays.

Due to the enormity of the computational effort for large circuits, the application of parallel processing to this problem has been explored. Unfortunately, large speedup performance for most systems and approaches have been elusive.

Sequential (uni-processor) logic simulation can be divided into two broad categories Compiled code and Event-driven simulation (Breur et al: Diagnosis and Reliable Design of Digital Systems. Computer-Science Press, New York (1976)). These techniques can be employed in a parallel environment by partitioning the circuit amongst processors. In compiled code simulation, all gates are evaluated at all time steps, even if they are not active. The circuit has to be levellised and only unit or zero delay models can be employed. Sequential circuits also pose difficulties for this type of simulation. A compiled code mechanism has been applied to several generations of specialised parallel hardware accelerators designed by IBM, the Logic Simulation Machine LSM (Howard et al: Introduction to the IBM Los Gatos Simulation Machine. Proc IEEE Int. Conf. Computer Design: VLSI in Computers. (October 1983) 580-583), the Yorktown Simulation Engine (Pfister: The Yorktown Simulation Engine. Introduction 19^{th} ACM/IEEE Design Automation Conf, (June 1982), 51-54) and the Engineering Verification Engine EVE (Dunn: IBM's Engineering Design System Support for VLSI Design and Verification. IEEE Design and Test Computers, (February 1984) 30-40 and performance figures as high as 2.2 billion gate evaluations/sec reported. Agrawal et al: Logic Simulation and Parallel Processing Intl Conf on Computer Aided Design (1990), have analysed the activity of several circuits and their results have indicated that at any time instant circuit activity (i.e. gates whose outputs are in transition) is typically in the range 1% to 0.1%. Therefore, the effective number of gate evaluations of these engines is likely to be smaller by a factor of a hundred or more. Speedup values ranging from 6 to 13 for various compiled coded benchmark circuits have been observed on the shared memory MIMD Encore Multimax multiprocessor by Soule and Blank: Parallel Logic Simulation on General purpose machines. Proc Design Automation Conf, (June 1988), 166-171. A SIMD (array) version was investigated by Kravitz (Mueller-Thuns et al: Benchmarking Parallel Processing Platforms: An Application Perspective. IEEE Trans on Parallel and Distributed systems, 4 No. 8 (August 1993) with similar results.

The intrinsic unit delay model of compiled code simulators is overly simplistic for many applications.

Some delay model limitations of compiled code simulation have been eliminated in parallel event-driven techniques. These parallel algorithms are largely composed of two phases; a gate evaluation phase and an event-scheduling phase. The gate evaluation phase identifies gates that are changing and the scheduling phase puts the gates affected by these changes (the fan-out gates) into a time-ordered linked schedule list, determined by the current time and the delays of the active gates. Soule and Blank: Parallel Logic Simulation on General purpose machines. Proc Design Automation Conf, (June 1988), 166-171 and Mueller-Thuns et al: Benchmarking Parallel Processing Platforms: An Application Perspective. IEEE Trans on Parallel and Distributed systems, 4 No 8 (August 1993) have investigated both Shared and Distributed memory Synchronous event MIMD architectures. Again, overall performance has been disappointing the results of several benchmarks executed on an 8-processor Encore Multimax and an 8-processor iPSC-Hypercube only gave speedup values ranging from 3 to 5.

Asynchronous event simulation permits limited processor autonomy. Causality constraints require occasional synchronisation between processors and rolling back of events. Deadlock between processors must be resolved. Chandy, Misra: Asynchronous Distributed Simulation via Sequence of parallel Computations. Comm ACM 24(ii) (April 1981), 198-206 and Bryant: Simulation of Packet Communications Architecture Computer Systems. Tech report MIT-LCS-TR-188. MIT Cambridge (1977) have developed deadlock avoidance algorithms, while Briner: Parallel Mixed Level Simulation of Digital Circuits Virtual Time. Ph.D. thesis. Dept of El. Eng, Duke University, (1990) and Jefferson: Virtual time. ACM Trans Programming languages systems, (July 1985) 404-425 have explored algorithms based on deadlock recovery. The best speedup performance figures for Shared and Distributed memory asynchronous MIMD systems were 8.5 for a 14-processor system and 20 for a 32-processor BBN system.

Optimising strategies such as load balancing, circuit partitioning and distributed queues are necessary to realise the best speedup figures. Unfortunately, these mechanisms themselves contribute large Overhead communication costs for even modest sized parallel systems. Furthermore, the gate evaluation process despite its small granularity, incurs between 10 to 250 machine cycles per gate evaluation.

### STATEMENTS OF INVENTION

The invention comprises a method and a processor for an Associated Parallel Processor for Logic Event Simulation; the processor is referred to in this specification as APPLES, and is specifically designed for parallel discrete event logic simulation and for carrying out such a parallel processing method. In summary, the invention provides gates evaluations in memory and replaces interprocessor communication with a scan technique. Further, the scan mechanism is so arranged as to facilitate parallelisation and a wide variety of delay models may be used.

Essentially, there is therefore provided a parallel processing method of logical simulation comprising representing signals on a line over a time period as a bit sequence, evaluating the output of any logic gate including an evaluation of any inherent delay by a comparison between the bit sequences of its inputs to a predetermined series of bit patterns and in which those logic gates whose outputs have changed over the time period are identified during the evaluation of the gate outputs as real gate changes and only those real gate changes are propagated to fan out gates. The control of the method is carried out in an associative memory mechanism which stores in word form a history of gate input signals by compiling a hit list register of logic gate state changes and using a multiple response resolver forming part of the associative memory mechanism which generates an address for each hit, and then scans and transfers the results on the hit list to an output register for subsequent use.

One of the core features of the invention is the segmentation or division of at least one of the registers or hit lists into smaller registers or hit lists to reduce computational time. The other feature of considerable importance is the handling of line signal propagation by modelling signal delays. Finally the method according to the invention allows simulation to be carried out over arbitrarily chosen time periods.

Either the associated register is divided into separate smaller associative sub-registers, one type of logic gate being allocated to each associative sub-register, each of which associative sub-registers has corresponding sub-registers connected thereto whereby gate evaluations and tests are carried out in parallel on each associative sub-register.

Alternatively it is possible to achieve a satisfactory simulation particularly where the circuit being simulated is not too large by segmenting the hit list into a plurality of separate smaller hit lists each connected to a separate scan register in this case each scan register is operated in parallel to transfer the results to the output register. This gets over the particular computational problem in these parallel processors and speeds up the whole simulation considerably.

Further, the invention provides a parallel processor for logic event simulation (APPLES) which essentially has an associated memory mechanism which comprises a plurality of separate associative sub-registers each for the storage in word form of a history of gate input signals for a specified type of logic gate. Further, there is a number of separate additional sub-registers associated with each associative sub-register whereby gate evaluations and tests can be carried out in parallel on each associative sub-register.

In the method according to the invention, each associative sub-register is used to form a hit list connected to a corresponding separate scan register.

Ideally, when there are a number of sub-registers and the number of the one type of logic gate exceeds a predetermined number, more than one sub-register is used.

Ideally, the scan registers are controlled by exception logic using an OR gate whereby the scan is terminated for each register on the OR gate changing state thus indicating no further matches. The predetermined number will be determined by the computational load.

The scan can be carried out in many ways but one of the best ways of carrying it out is by sequential counting through the hit list and when this is done, generally the steps are performed of:—
checking if the bit is set indicating a hit;
if a hit, determining the address effected by that hit;
storing the address;
clearing the bit in the hit list;
moving to the next position in the hit list; and
repeating the above steps until the hit list is cleared.

Obviously where fan out occurs subsequently more than one address will be effected.

In one particular embodiment of the invention, there is provided such a parallel processing method of logic simulation in which each line signal to a target logic gate is stored as a plurality of bits each representing a delay of one time period, the aggregate bits representing the delay between signal output to and reception by the target logic gate and in which the inherent delay of each logic gate is represented in the same manner. The time period is arbitrarily chosen and will often be of the order of 1 nanosecond or less. The fact that the time period can be arbitrarily chosen is of immense importance since it is possible to simulate a circuit for a plurality of different time periods. Additionally the affect of the delay inherent in the transfer of line signal between logic gates is becoming more important as the response time of the components of circuits reduce.

In this latter embodiment, each delay is stored as a delay word in an associative memory forming part of the associative memory mechanism in which:—
the length of the delay word is ascertained; and
   if the delay word width exceeds the associative register word width:—
the number of integer multiples of the register word width contained within the delay word is calculated as a gate state;
the gate state is stored in a further state register;
the remainder from the calculation is stored in the associative register with those delay words whose widths did not exceed the associative register word width; and
   on the count of the associative register commencing:—
the state register is consulted for the delay word entered in the state register and the remainder is ignored for this count of the associative register;
at the end of the count of the associative register, the state register is updated; and
the count continues until the remainder represents the count still required.

For carrying out the invention, an initialisation phase is carried out in which specified signal values are inputted, unspecified signal values are set to unknown, test templates are prepared defining the delay model for each logic gate, the input circuit is parsed to generate an equivalent circuit consisting of 2-input logic gates, and the 2-input logic gates are then configured.

With the present invention, multi-valued logic may be applied and in this situation, n bits are used to represent a signal value at any instance in time with n being any arbitrarily chosen logic. A particularly suitable one is an 8-valued logic in which 000 represents logic 0, 111 represents logic 1 and 001 to 110 represent arbitrarily defined other signal states.

One of the features of the invention is that the sequence of values on a logic gate is stored as a bit pattern forming a unique word in the associative memory mechanism and by doing this it is possible to store a record of all values that a logic gate has acquired for the units of delay of the longest delay in the circuit.

### DETAILED DESCRIPTION OF THE INVENTION

The invention will be more clearly understood from the following description of embodiments thereof given by way of example only with reference to the accompanying drawings in which:—

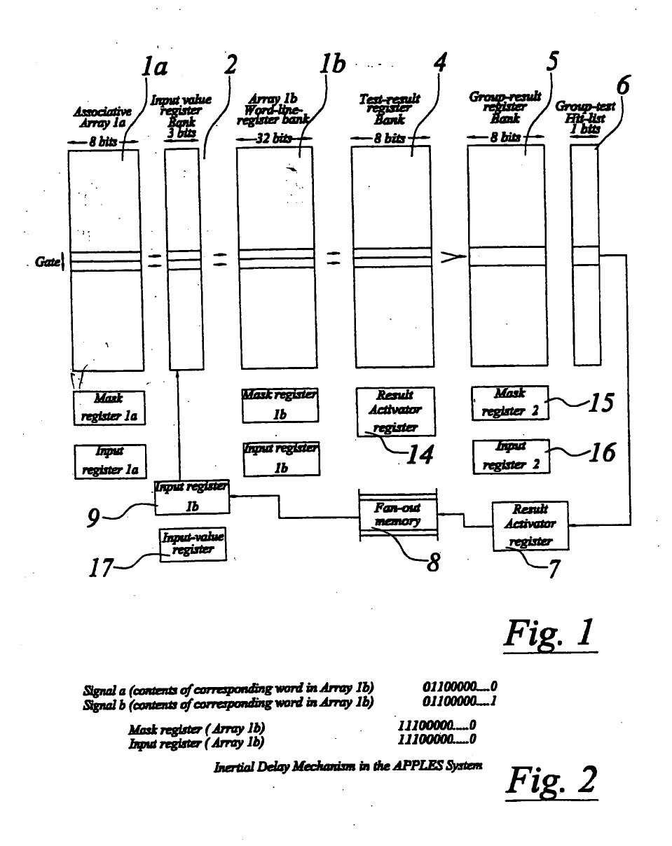

FIG. 1 illustrates the functions of blocks of the APPLE processor;

FIG. 2 illustrates the inertial delay mechanism in the APPLE system;

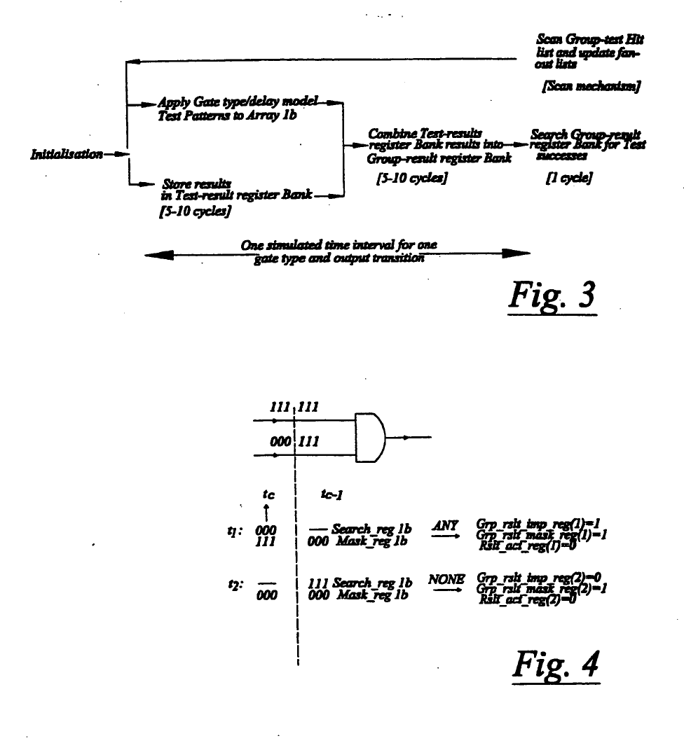

FIG. 3 is an illustration of a simulated cycle;

FIG. 4 is a test search pattern;

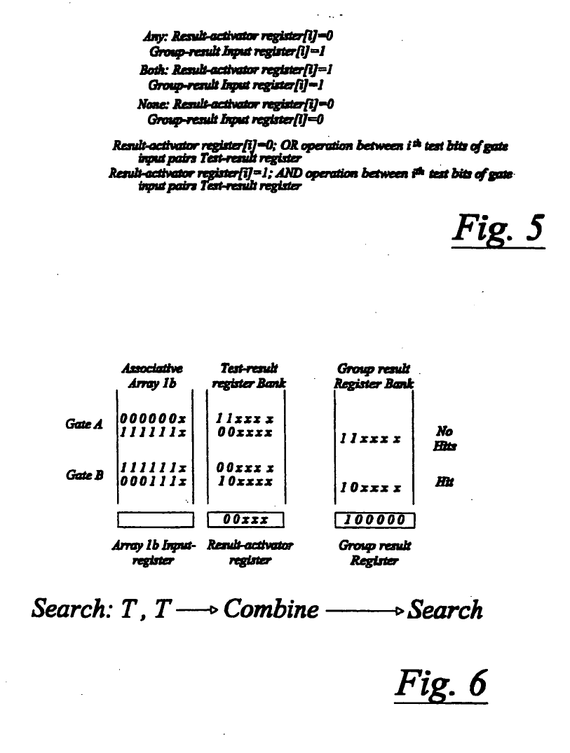

FIG. 5 is an illustration of the logical combination mechanism according to the invention,

FIG. 6 illustrates components active during a gate evaluation phase,

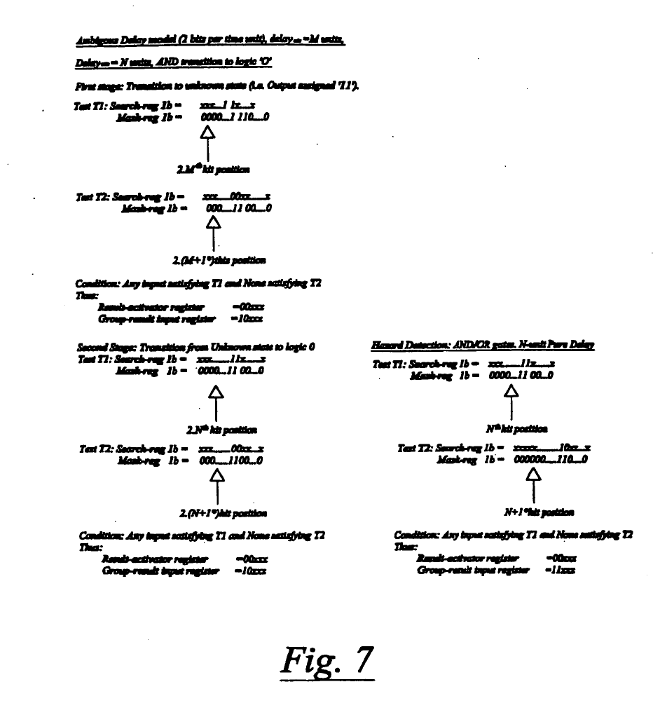

FIG. 7 is bit patterns for an ambiguous delay model and hazard detection,

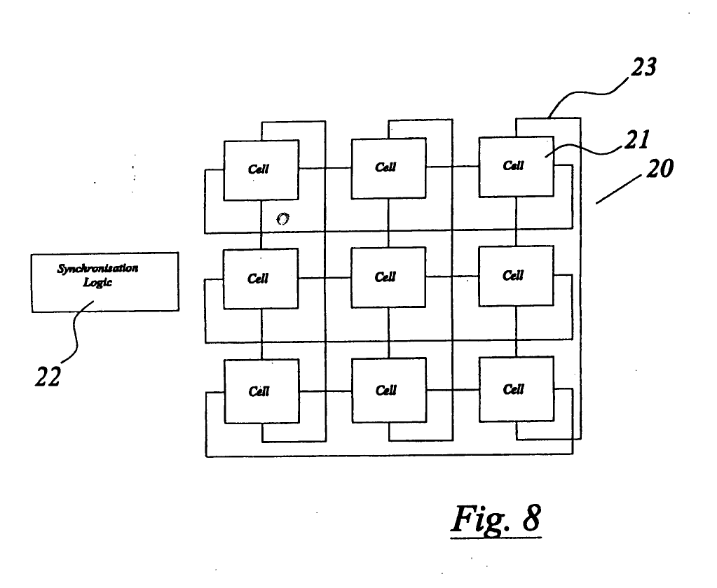

FIG. 8 is an outline of an alternative arrangement of processors according to the invention;

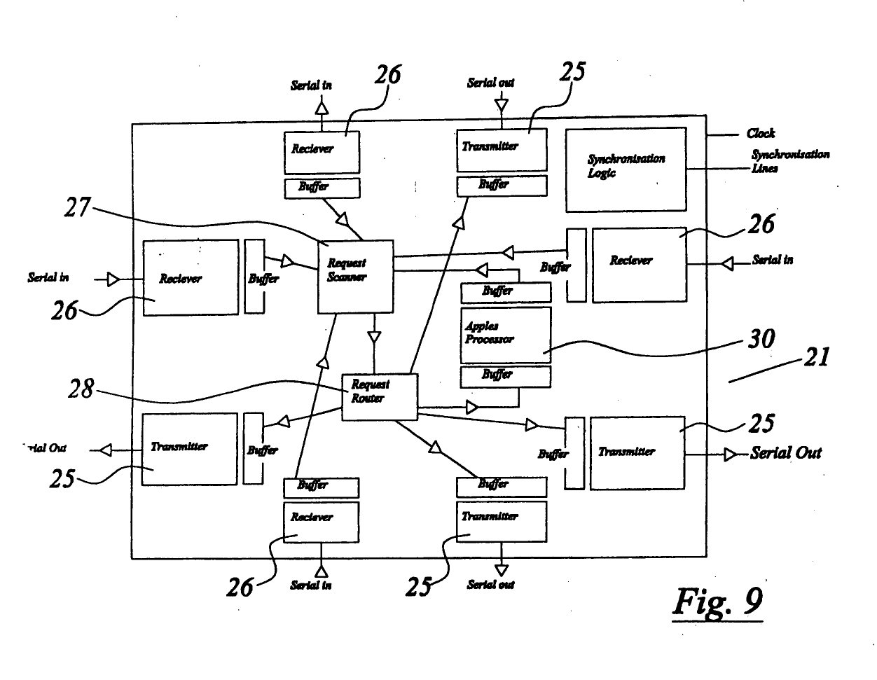

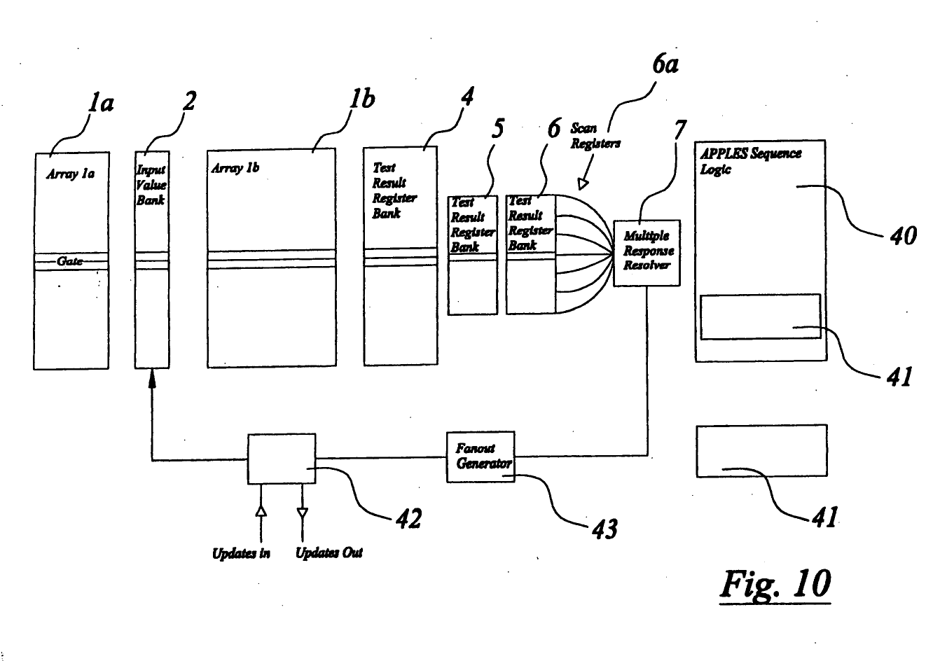

FIG. 9 illustrates the structure of one processor in more detail; and

FIG. 10 is a view similar to FIG. 1 of the alternative construction of processor.

The essential elemental tasks for parallel logic simulation are:

1. Gate evaluation.

2. Delay model implementation.

3. Updating fan-out gates.

The design framework for a specific parallel logic simulation architecture originated by identifying the essential elemental simulation operations which can be performed in parallel and by minimising the tasks that support these operations and which are totally intrinsic to the parallel system.

Activities such as event scheduling and load balancing are perceived as implementation issues which need not be incorporated necessarily into a new design. An important additional critique is that the design must execute directly in hardware as many parallel tasks as possible, as fast as possible but without limiting the type of delay model.

The present invention, taking account of the above objectives, incorporates several special associative memory blocks and hardware in the APPLES architecture.

The gate evaluation/delay model implementation and Update/Fan-out process will be explained with reference to the APPLES architecture with reference to FIG. 1.

Referring to FIG. 1, the functional blocks of the APPLES processor are shown. The blocks pertinent to gate evaluation are associative array 1a 1, input-value-register bank 2, associative array 1b, test-result-register bank 4, group-result register bank 5 and the group-test hit list 6. The group test hit list in turn feeds a multiple response resolver 7 which in turn feeds a fan out memory 8 to an address register 9 connected to the input value register bank 2. The associative array 1 has an associative mask register 1a and input register 1a while the associative array 1b has a mask register 1b and an input register 1b. Similarly, the test result register bank 4 has a result active register 14 and the group result register bank 5 has a mask register 15 and an input register 16. Finally, an input value register bank 17 is provided. Apart from the associative arrays, the group-result register bank has parallel search facilities. Regardless of the number of words in these structures can be searched in parallel in constant time. Furthermore, the words in the input-value-register bank 17 and associative array 1b can be shifted right in parallel while resident in memory.

A gate can be evaluated once its input wire values are known. In conventional uni-processor and parallel systems these values are stored in memory and accessed by the processor(s) when the gate is activated. In APPLES, gate signal values are stored in associative memory words. The succession of signal values that have appeared on a particular wire over a period of time are stored in a given associative memory word in a time ordered sequence. For instance, a binary value model could store in a 32-bit word, the history of wire values that have appeared over the last 32 time intervals. Gate evaluation proceeds by searching in parallel for appropriate signal values in associative memory. Portions of the words which are irrelevant (e.g. only the 4 most recent bits are relevant for a 4-unit gate delay model) are masked out of the search by the memory's input and mask register combination. For a given gate type (e.g. And, Or) and gate delay model there are requirements on the structure of the input signals to effect an output change. Each pattern search in associative memory detects those signal values that have a certain attribute of the necessary structure (e.g. Those signals which have gone high within the last 3 time units). Those wires that have all the attributes indicate active gates. The wire values are stored in a memory block designated associative array 1b(word-line-register bank). Only those gate types relevant to the applied search patterns are selected. This is accomplished by tagging a gate type to each word. These tags are held in associative array 1a. A specific gate type is activated by a parallel search of the designated tag in associative Array1a.

This simple evaluation mechanism implies that the wires must be identified by the type of gate into which they flow since different gate types have different input wire sequences that activate them. Gates of a certain type are selected by a parallel search on gate type identifiers in associative array 1a.

Each signal attribute corresponds to a bit pattern search in memory. Since several attributes are normally required for an activated gate, the result of several pattern searches must be recorded. These searches can be considered as tests on words.

The result of a test is either successful or not. This can be recorded as single bit in a corresponding word in another register held in a register bank termed the test-result-register bank. Since each gate is assumed to have two inputs (inverters and multiple input gates are translated into their 2-input gate circuit equivalents) tests are combined on pairs of words in this bank. This combination mechanism is specific to a delay model and defined by the result-activator register and consists of simple AND or OR operation between bits in the word pairs.

The results of each combining each word pair, the final stage of the gate evaluation process, are stored as a single word in another associative array, the group-result register Bank 5. Active gates will have a unique bit pattern in this bank and can be identified by a parallel search for this bit pattern. Successful candidates of this search set their bit in the 1-bit column register group-test hit list.

The bits in each column position of every gate pair in the test-result register bank 4 are combined in accordance to the logic operators defined in the result-activator register. The bits in each column are combined sequentially in time in order to reduce the number of output lines in the test-result-register bank 4. Thus, there is only one output line required for each gate pair in the test-result register bank, instead of one wire for each column position.

The result of the combination of gate pairs in the test-result register bank 4 are written column by column into the group-result register bank 5. Only one column in parallel is written at a particular clock edge. This implies only one input wire to the group-result register bank 5 is required per gate pair in the test-result register bank.

This reduces the number of connections from the test-result register bank to the group-result register bank.

The scan registers are independent in so far as they can be decremented or incremented while other scan registers are disabled, however they are clocked in unison by one clock signal.

The optimum number of scan registers is given by the inverse of the probability of a hit being detected in the hit list.

It is essential that an OR operations of all bits in the Hit-list is computed on one edge of a clock period to determine when all hit bits are clear and on the converse edge of the same clock cycle any scan register that is given access to its fan-out list is permitted to clear the hit bit that it has detected. The access is controlled by a wait semaphore system to ensure only one access at a time is made to each single ported memory.

An alternative system consists of a multi-ported fan-out memory, consisting of several memory banks each of which can be simultaneously accessed. Each memory bank in the system has its own semaphore control mechanism.

An alternative strategy has a hit bit enable the inputs of its fan-out list in the Input-value register. The enable connections from the hit list to the appropriate elements in the Input-value register bank are made prior to the commencement of the simulation and are determined by the connectivity between the gates in the circuit being simulated. These connections can be made by a dynamically configured device such as an FPGA (Field Programmable Gate Array) which can physically route the hit list element to its fan-out inputs. In the process all active Fan-out elements so connected will be enabled simultaneously and updated with the same logic value in parallel.

The control core consists of a synchronised self-regulated sequence of events identified in one example, the Verilog code as e0, e1, e2 etc. An event corresponds to the completion of a major task. The self-regulation means that there is no software controlling the sequence of events, although there may be software external to the processor which will solicit information concerning the status of the processor. Furthermore, it implies that there is no microprogramming involved in the design. This eliminates the need for a microprogrammed unit and increases the speed of processing.

In the fan-out update activity controlled, for example, by e20, it is essential that the event that the Multiple response resolver 7 has no more hits to be detected, terminates this activity. There is a choice that this activity be terminated by the event that all the hit-list has been scanned. However, detection that no more hits exist can terminate prematurely this fan-out update procedure and leads to a faster execution time of this procedure.

Some logic entities may have delays which exceed the time frame representable in the word of associative array 1b. Larger delays can be modelled by associating a state with a gate type. In this case a gate and its state are defined in associative array 1a. Tests are performed on associative array 1b and when a gate with a given state passes some input value critique in addition to the fan-out components of the gate possibly being affected, the Gate state is amended in Associative array 1a. This new state may also cause a new output value to be ascribed to the fan-out list of the gate. The tests that are applied are determined by the gate type and state. In this mechanism the fan-out list of a gate includes the normal fan-out inputs and the address in associative array 1a of the gate itself.

In order to determine whether the state or the state and the fan-out gates are to be updated the state (a binary value) can serve as an offset into the gate's fan-out update data files. The state is added to the start location of each of a gates data files and this enables the gates normal fan-out list to be bypassed or not.

The interconnect between logic entities being simulated can be modelled using a large delay model described below. Furthermore, single wires can be modelled by one word instead of two in associative array 1a, associative array 1b and the test-result register bank 4. Branch points are modelled as separate wires permitting different branch points to have different delay characteristics.

An efficient implementation uses single word versions of associative array 1a, associative array 1b and the test-result register bank.

The APPLES gate evaluation mechanism selects gates of a certain type, applies a sequence of bit patterns searches (tests) to them and ascertains the active gates by recording the result of each pattern search and determining those that have fulfilled all the necessary tests. This mechanism executes gate evaluation in constant time—the parallel search is independent of the number of words. This is an effective linear speedup for the evaluation activity. It also facilitates different delay models since a delay model can be defined by a set of search patterns. Further discussion of this is given below.

Active gates set their bits in the column hit list. A multiple response resolver scans through this list. The multiple resolver can be a single counter which inspects the entire list from top to bottom which stops when it encounters a set bit and then uses its current value as a vector for the fan-out list of the identified active gate. This list has the addresses of the fan-out gate inputs in an input-value register bank. The new logic value of the active gates are written into the appropriate word of this bank.

It then clears the bit before decrementing through the remainder of the list and repeating this process. All hit bits are Ored together so that when all bits are clear. This can be detected immediately and no further scanning need be done.

Several scan registers can be used in the multiple response resolver to scan the column hit list in parallel. Each operates autonomously except when two or more registers simultaneously detect a hit; a clash has occurred. Then each scan register must wait until it is arbitrarily allowed to access and update its fan-out list. Each register scans an equal size portion. The frequency of clashes depends on the probability of a hit for each scan register, typically this probability is between 0.01 and 0.001 for digital circuits. The timing mechanism in APPLES enables only active gates to be identified and the multiple scan register structure provides a pipeline of gates to be updated for the current time interval without an explicit scheduling mechanism. The scheduler has been substituted by this more efficient parallel scan procedure.

When all gate types have been evaluated for the current time interval all signals are updated by shifting in parallel the words of the Input-value register into the corresponding words of the word-line register bank. For 8 valued logic (i.e. 3 bits for each word in the Input-value register) this phase requires 3 machine cycles. The input-value register bank can be implemented as a multi-ported memory system which allows several input values to be updated simultaneously provided that the values are located in different memory banks. Other logic values can be used.

The APPLES bit shift mechanism has made the role of a scheduler redundant. Furthermore, it enables the gate evaluation process to be executed in memory, thereby avoiding the traditional Von Neumann bottleneck. Each word pair in array 1b is effectively a processor. Major issues which cause a large overhead in other parallel logic simulation are “deadlock” and scheduling issues.

Deadlock occurs in the Chandy-Misra algorithm due to two rules required for temporal correctness, an input waiting rule and an output waiting rule. Rule one is observed by the update mechanism of APPLES. For any time interval Tᵢ to Tᵢ₊₁. All words in array 1b reflect the state of wires at time Tᵢ and at the end of the evaluation and update process all wires have be updated to time Tᵢ₊₁. All wires have been incremented by the smallest timestamp, one discrete time unit. Thus at the start of every time interval all gates can be evaluated with confidence that the input values are correct. The Output rule is imposed to ensure that a signal values arrive for processing in non-decreasing timestamp order. This is guaranteed in APPLES, since all signal values maintain there temporal order in each word through the shift operation. Unlike the Chandy-Misra algorithm deadlock is impossible as every gate can be evaluated at each time interval.

There is no scheduler in the APPLES system. Complex modelling such as Inertial delays have confronted schedulers with costly (timewise) unscheduling problems. Gates which have been scheduled to become active need to be de-scheduled when input signals are found to be less than some predefined minimum duration. This with the normal scheduling tasks contributes to an onerous overhead.

FIG. 2 displays the equivalent mechanism in APPLES. An AND gate has two inputs a and b, assume that unless signals are at least of three units duration no effect occurs at the output, the simulation involves only binary values 0 and 1 and each bit in Array1b represents one time unit. Signal b is constant at value 1, while signal a is at logic 1 for two time units, less than the minimum time. This will be detected by the parallel search generated by the input and mask register combination and the gate will not become active.

The circuit is now ready to be simulated by APPLES and is parsed to generate the gate type and delay model and topology information required to initialise associative arrays 1a, 1b and the fan-out vector tables. There is no limit on the number of fan-out gates.

The APPLES processor assumes that the circuit to be simulated has been translated into an equivalent circuit composed solely of 2-input logic gates. Thus, every gate has two wires leading into it (an inverter has two wires from one source). These wires are organised as adjacent words in associative array 1b 1 called a word set. Associative array 1a 1 contains identifiers from every wire indicated the type of gate and input into which the wire is connected. The identifiers are in an associative memory that when a particular gate evaluation test is executed, putting the relevant bit patterns into Input-reg1a and mask-reg1a specifies the gate type. All wires connected to such gates will be identified by a parallel search on associative array 1a and these will be used to activate the appropriate words in associative array 1b (word-line register bank). Thus, gate evaluation tests will only be active on the relevant word sets.

The input-value register bank 17 contains the current input value for each wire. The three leftmost bits of every word in associative array 1b are shifted from this bank in parallel when all signal values are being updated by one time unit. During the update phase of the simulation, fan-out wires of active gates are identified and the corresponding words in the Input-value register bank amended.

Simulation progresses in discrete time units. For any time interval, each gate type is evaluated by applying tests on associative array 1b and combining and recording results in the neighbouring register banks. Regardless of the number of gates to be evaluated this process occupies between 10 machine cycles for the simplest, to 20 machine cycles for the more complex gate delay models, see FIG. 3. Once the fan-out gate inputs have been amended, all wires are time incremented through a parallel shift operation of 3 machine cycle duration. In general, for 2^{N} valued logic N shift operations are required to update all signal values.

FIG. 3 illustrates a simulation cycle. In the simulation cycle, the task particularly affected by the circuit size is that of scanning the hit list. As a circuit grows in size the list and sequential scan time expand proportionately. Analogous to the conventional communication overhead problem, the APPLES architecture incorporates a scan mechanism which can effectively increase the scan rate as the hit list expands. Thus, there is provided a multiple scan register structure. As will be described, one of the features of the present invention is the parallelisation of the application of test vectors in the gate evaluation phase as will be described hereinafter. Similarly, FIG. 4 is a search test pattern for an AND gate.

The series of signal values that appear on a wire over a period of discrete time units can be represented as a sequence of numbers. For example, in a binary system if a wire has a series of logic values, 1,1,0 applied to it at times t₀, t₁ and t₂ respectively, where t₀<t₁<t₂. The history of signal values on this wire can be denoted as a bit sequence 011; the further left the bit position, the more recent the value appeared on the wire.

Different delay models involve signal values over various time intervals. In any model, signal values stored in a word which are irrelevant are masked out of the search pattern.

The process of updating the signal values of a particular wire is achieved by shifting right by one time unit all values and positioning the current value into the leftmost position. Associative array 1b can shift right all its words in unison. The new current values are shifted into associative array 1b from the Input-value register bank.

Referring to FIG. 4, there is illustrated the parallel search patterns for an AND gate transition to logic “0”.

With wire signal values represented as bit sequences in associative memory words, the task of gate evaluations can be executed as a sequence of parallel pattern searches. FIG. 4 depicts the situation where 8-valued logic has been employed and the AND gate has been arbitrarily modelled as having a 1 unit delay.

Any gate which has any input satisfying T₁ and no(none) input satisfying T₂ will transition to 0.

Consequently, to determine if the output of this gate is going to transition from logic 1 to logic 0 it is necessary to know the signal values at the current time t_{c} and t_{c-1}. The current values are contained in the leftmost three bits of the word set. FIG. 4 declares the current values on the two inputs as logic 1=‘111’ and logic 0=‘000’ and the previous values as both logic 1.

To ascertain if this AND gate has an output transition to logic 0, two simple bit pattern tests will suffice. If ANY current input value is logic 0 (Test T₁) and NONE of the previous input values are logic 0 (Test T₂), then the output will change to logic 0. These are the only conditions for this delay model, which will effect this transition. With associative memory any portion of a word can be active or passive in a search. Thus, putting ‘000’ and ‘111’ into the leftmost three bits of the search and mask registers of associative array 1b can execute test T₁. Test T₂ can be executed by essentially the same test on the next leftmost three bit positions.

In general each test is applied one at a time. The result of test Tᵢ on wordⱼ is stored in the i^{th} bit position of wordⱼ in the test-result register bank 4. A ‘1’ indicates a successful test outcome. For each word set, for every test it is necessary to know if ANY or BOTH or NONE of the inputs passed the particular test. If the i^{th} bits of wordⱼ and wordⱼ₋₁ in the test-result register bank are Ored together and the result of this operation is ‘1’, then at least one input in the corresponding word set passed the test Tᵢ—the ANY condition test. If the result of the operation is ‘0’ then no inputs passed test Tᵢ—the NONE condition test. Finally, if the i^{th} bits are Anded together and the result is ‘1’ then BOTH have passed test Tᵢ.

The result-activator register 14 combines results which are subsequently ascertained by the group-result register. The logical interaction is shown in FIG. 5.

The And or Or operations between the bit positions is dictated by the result activator register. A ‘0’ in the i^{th} bit position of the result activator register performs an Or action on the results of test Tᵢ for each word set in the test-result register bank and conversely a ‘1’ an And action. Each i^{th} And or Or operation is enacted in parallel through all word set Test result register pairs.

The results of the activity of the result activator register on each word set Test result register pair are saved in an associated group result register. Apart from retaining the results for a particular word set, the group result registers are composite elements in an associative array. This facilitates a parallel search for a particular result pattern and thus identifies all active gates. These gates are identified as hits (of the search in the group result register bank) in the group-test hit list.

Returning to the AND gate transition to logic ‘0’ example, an AND gate will be identified as fulfilling the test requisites, any input passes test T₁ and none passing test T₂, if its corresponding group result register has the bit sequence ‘10’ in the first two bit positions.

The APPLE components involved in the gate evaluation phase and their sequencing are shown in FIG. 6.

With the present invention, one of the major features of the method is the storing of each line signal to a target logic gate as a plurality of bits, each representing a delay of one time period. The aggregate bits will allow the signal output to and reception by the target logic gate to be accurately expressed. Thus, these are represented in the same manner as the inherent delay of each logic gate. What must be appreciated now is that as the speed of circuits increases, the time taken to transmit a message between two logic gates can be considerable. Thus, the lines, as well as the logic gates, have to be considered as logic entities.

Some logic entities may have delays which exceed the time frame representable in the word of associative array 1b. Larger delays can be modelled by associating a state with a gate type. In this case a gate and its state are defined in associative array 1a. Tests are performed on associative array 1b and when a gate with a given state passes some input value critique, in addition to the fan-out components of the gate possibly being affected, the Gate state is amended in Associative array 1a. This new state may also cause a new output value to be ascribed to the fan-out list of the gate. The tests that are applied are determined by the gate type and state. In this mechanism the fan-Array 1a of the gate itself.

In order to determine whether the state or the state and the fan-out gates are to be updated the state (a binary value) can serve as a selector of the gate's fan-out update data files. The state amends the access point relative to the start location of a gates data files and this enables the gates normal fan-out list to be bypassed or not

On commencement of filling a new time frame (a word in associative array 1b), a special symbol is inserted into the left-most (most recent time) position. This symbol conveys the input value on the gate and serves as a marker. When the marker reaches the right-most position in the word, this indicates that a complete time frame has passed. This can be detected by the normal parallel test-pattern search technique on associative array 1b (See FIG. 1).

The interconnect between logic entities being simulated can be modelled using the large delay model described above. Furthermore, single wires can be modelled by one word instead of two in associative array 1a, associative array 1b and the test-result register bank. Branch points are modelled as separate wires permitting different branch points to have different delay characteristics.

In effect, what is done is each delay is stored as a delay word in an associative memory forming part of the associative memory mechanism. The length of the delay word is ascertained and if the delay word width exceeds the associative register word width, then it cannot be stored in the register simply. Then, the number of integer multiples of the register word width contained within the delay word is calculated as a gate state. This gate state is stored in a further state register, in effect, the associative register or associative array 1a. The remainder from the calculation is stored in the associative register array 1b with those delay words whose width did not exceed the associative register width as well as with those words who did. Then, on the count of the associative register 16 commencing, the state register is consulted, that is to say, the associative register 1a, and the delay word entered into the register. The remainder is ignored for this count of the associative register array 1b. At the end of the count of the associative register 1b, the associative register 1a is updated by decrementing one unit. If this still does not allow the count to take place, the process is repeated. If, however, the associative register 1a is cleared, then the count continues and the remainder now represents the count required.

Complex delay models such as inertial delays require conventional sequential and parallel logic simulators to unschedule events when some timing critique is violated. This expends an extremely time consuming search through an event list. In the present invention, inertial delays only require verification that signals are at least some minimum time width; implementable as a single pattern search.

An ambiguous delay is more complicated where the statistical behaviour of a gate conveys an uncertainty in the output. A gate output acquires an unknown value between some parameters tₘᵢₙ (M time units) and tₘₐₓ (N time units). Using 4-valued logic, APPLES detects an initial output change to the unknown value at time tₘᵢₙ, followed by the transition from unknown value to logic state ‘0’ at time tₘₐₓ, see FIG. 7. Hazard conditions, where both inputs simultaneously switch to converse values can also be detected, which is illustrated in FIG. 7.

For each gate type, the evaluation time T_{gate-eval} remains constant, typically ranging from 10 to 20 machine cycles. The time to scan the hit list depends on its length and the number of registers employed in the scan. N scan registers can divide a Hit list of H locations into N equal partitions of size H/N. Assuming a location can be scanned in 1 machine cycle, the scan time, Tscan is H/N cycles. Likewise it will be assumed that 1 cycle will be sufficient to make 1 fan-out update.

For one scan register partition, the number of updates is (Probₕᵢₜ)H/N. If all N partitions update without interference from other partitions this also represents the total update time for the entire system. However, while one fan-out is being updated, other registers continue to scan and hits in these partitions may have to wait and queue. The probability of this happening increases with the number of partitions and is given by ^{N}C₁(Probₕᵢₜ)H/N.

A clash occurs when two or more registers simultaneously detect a hit and attempt to access the single ported fan-out memory. In these circumstances, a semaphore arbitrarily authorises waiting registers accesses to memory. The number of clashes during a scan is,
No. clashes=(Prob of 2 hits per inspection)×H/N+Higher order probabilities. (1)
The low activity rate of circuits (typically 1%-5% of the total gate count) implies that higher order probabilities can be ignored. Assume a uniform random distribution of hits and let Probₕᵢₜ be the probability that the register will encounter a hit on an inspection. Then (1) becomes,
No. clashes=^{N}C₂(Probₕᵢₜ)²×H/N (2)
Thus, T_{N}, the average total time required to scan and update the fan-out lists of a partition for a particular gate type is,

$$\begin{matrix}{T}_{N} = {T}_{gate \text{-} eval} + {T}_{scan} + {T}_{update} + {T}_{clash} \\ = {T}_{gate \text{-} eval} + H / N + {}_{}^{N}{C}{}_{1}^{} ( {Prob}_{hit} ) H / N + \\ {{}_{}^{N}{C}{}_{2}^{} ( {Prob}_{hit} )}^{2} \times H / N\end{matrix} \qquad ( 3 )$$

Since all partitions are scanned in parallel, T_{N} also corresponds to the processing time for an N scan register system. Thus, the speedup Sₚ=T₁/T_{N}, of such as system is,

$${T}_{1} / {T}_{N} = \frac{{T}_{gate \text{-} eval} + {T}_{scan} + {T}_{update}}{\begin{matrix}{T}_{gate \text{-} eval} + H / N + {}_{}^{N}{C}{}_{1}^{} ( {Prob}_{hit} ) H / N + \\ {{}_{}^{N}{C}{}_{2}^{} ( {Prob}_{hit} )}^{2} \times H / N\end{matrix}} \qquad ( 4 )$$

Eqt (4) has been validated empirically. Predicted results are within 20% of observed for sample circuits C7552 and C2670 and 30% for C1908. Non-uniformity of hit distribution appears to be the cause for this deviation.

Differentiating T_{N} w.r.t N and ignoring 2^{nd} order and higher powers of Probₕᵢₜ the optimum number of scan registers Nₒₚₜᵢₘᵤₘ and corresponding optimum speedup Sₒₚₜᵢₘᵤₘ is given by,
Nₒₚₜᵢₘᵤₘ≅(√2)/Probₕᵢₜ (5)
Sₒₚₜᵢₘᵤₘ≅1/(2.4×Probₕᵢₜ) (6)
Thus, the optimum number of scan registers is determined inversely by the probability of a hit being encountered in the Hit list. In APPLES, the important processing metric is the rate at which gates can be evaluated and their fan-out lists updated. As the probability of a hit increases there will be a reciprocal increase in the rate at which gates are updated. Circuits under simulation which happen to exhibit higher hit rates will have a higher update rate.

When the average fan-out time is not one cycle, Probₕᵢₜ is multiplied by Fout, where Fout is the effective average fan-out time.

A higher hit rate can also be accomplished through the introduction of extra registers. An increase in registers increases the hit rate and the number of clashes. The increase halts when the hit rate equals the fan-out update rate, this occurs at Nₒₚₜᵢₘᵤₘ. This situation is analogous to a saturated pipeline. Further increases in the number of registers serves to only increase the number of clashes and waiting lists of those registers attempting to update fan-out lists.

Further simulations were carried out, again with a Verilog model of APPLES simulated 4 ISCAS-85 benchmarks, C7552(4392 gates), C2670(1736 gates), C1908(1286 gates), C880(622 gates) using a unit delay model. Each was exercised with 10 random input vectors over a time period ranging from 1,000 to 10,000 machine cycles. Statistics were gathered as the number of scan registers varied from 1 to 50. The speedup relative to the number of scan registers is shown in Table 1.

TABLE 1
Speedup Performance of Benchmarks

| | | | | | Speedup (excl Fixed | | | |
|---|---|---|---|---|---|---|---|---|
| | Speedup | | | | size Overheads) | | | |
| | (a) | | | | (b) | | | |
| | No. Scan Registers | | | | No. Scan Registers | | | |
| | 1 | 15 | 30 | 50 | 1 | 15 | 30 | 50 |
| C7552 | 1 | 12.5 | 19.9 | 24.3 | 1 | 13.6 | 24.3 | 29.6 |
| C2670 | 1 | 9.7 | 13.8 | 15.9 | 1 | 12.5 | 20.0 | 25.1 |
| C1908 | 1 | 8.4 | 10.8 | 11.8 | 1 | 11.8 | 17.3 | 20.9 |
| C880 | 1 | 7.8 | 8.3 | 9.7 | 1 | 11.1 | 12.6 | 15.9 |

Table (1.a) demonstrates that in general the speedup increases with the number of scan registers. The fixed sized overheads of gate evaluation, shifting inputs etc, tends to penalise the performance for the smaller circuits with a large number of registers. A more balanced analysis is obtained by factoring out all fixed time overheads in the simulation results. This reflects the performance of realistic, large circuits where the fixed overheads will be negligible to the scan time. Table (1.b) details the results with this correction. As expected this correction has lesser affect on the larger bench mark circuits.

TABLE 2
Average No. of machine cycles per gate processed

Av. No. Cycles/
Gate Processed
No. Scan Registers

| | 1 | 15 | 30 | 50 |
|---|---|---|---|---|
| C7552 | 154.6 | 11.3 | 6.4 | 5.2 |
| C2670 | 101.9 | 8.0 | 5.1 | 3.9 |
| C1908 | 86.9 | 6.8 | 5.1 | 3.9 |
| C880 | 49.9 | 4.9 | 4.2 | 3.6 |

Taking the corrected simulated performance statistics, Table (2) displays the average number of machine cycles expended to process a gate. The APPLES system detects intrinsically only active gates, no futile updates or processing is executed. The data takes into account the scan time between hits and the time to update the fan-out lists. As more registers are introduced the time between hits reduces and the gate update rate increases. Clashes happen and active gates are effectively queued in a fan-out/update pipeline. The speedup saturates when the fan-out/update rate, governed by the size of the average fan-out list, equals the rate at which they enter the pipeline.

The benchmark performance of the circuits also permits an assessment of the validity of the theory for the speedup. From the speedup measurements in Table 1.(b) the corresponding value for fₐᵥ was calculated using Eqt(7). This value representing the average fan-out update time in machine cycles, should be constant regardless of the number of scan registers. Furthermore, for the evaluated benchmarks the fan-out ranged from 0 to 3 gates and the probability of a hit, Probₕᵢₜ, was found to be 0.01±5%. Within one and a half clock cycles it is possible to update 2 fan-out gates, therefore depending on the circuit fₐᵥ should be in the range 0.5 to 1.5. The calculated values fₐᵥ for are shown in Table 3.

TABLE 3
The Average Fan-out Update Time (in machine
cycles) for the Benchmarks

| | No. Scan | | |
|---|---|---|---|
| | Registers | | |
| | 15 Av | 30 | 50 |
| C7552 | 0.41 | 0.35 | 0.88 |
| | 0.55 | | |
| C2670 | 0.52 | 0.79 | 1.26 |
| | 0.86 | | |
| C1908 | 0.77 | 1.21 | 1.32 |
| | 1.10 | | |
| C880 | 0.16 | 1.98 | 1.54 |
| | 1.22 | | |

fₐᵥ

The values for fₐᵥ are in accord with the range expected for the fan-out of these circuits. The fluctuations in value across a row for fₐᵥ, where it should be constant are possibly due to the relatively small number of samples and size of circuits, where a small perturbation in the distribution of hits in the hit-list can affect significantly the speedup figures. In the case of C880, a 10% drop in speedup can effectively lead to a ten-fold increase in fₐᵥ.

For comparison purposes Table 4 uses data from Banerjee: Parallel Algorithms for VLSI Computer-Aided Design. Prentice-Hall, 1994 which illustrates the speedup performance on various parallel architectures for circuits of similar size to those used in this paper. This indicates that APPLES consistently offers higher speedup.

For comparison purposes Table 4 uses data from Banerjee: Parallel Algorithms for VLSI Computer-Aided Design. Prentice-Hall, 1994 which illustrates the speedup performance on various parallel architectures for circuits of similar size to those used in this paper. This indicates that APPLES consistently offers higher speedup.

TABLE 4
A speedup comparison of other parallel architectures

| | Synchronous | | Asynchronous | |
|---|---|---|---|---|
| | Shared | Distributed | Shared | Distributed |
| Architecture | Memory | Memory | Memory | Memory |
| Circuit | | | | |
| Multiplier | 5.0/8 | / | 5.0/8, 5.8, 14 | / |
| (4990 gates) | | | | |
| H-FRISC | 3.7/8 | / | 7.0/8, 8.2/14 | / |
| (5060 gates) | | | | |
| S15850 (9772 | / | 3.2/8 | / | / |
| gates) | | | | |
| S13207 (7951 | / | 3.2/8 | / | / |
| gates) | | | | |
| Adder (400 | / | / | 4.5/16, 6.5/32 | / |
| gates) | | | | |
| QRS (1000 | / | / | 5.0/16, 7.0/32 | / |
| gates) | | | | |

Speedup Performance for Various Parallel Systems
Notation a/b, where a = Speedup value, b = No. Processors.
Double entries denote two different systems of the same architecture

The following from pages 28 to 54 is one example of an implementation of the present invention in software written in Verilog.

Verilog Description of APPLES

Associative Array1a

Description: Each word of this array holds a bit sequence identifying the gate type input connection of a wire, in the corresponding position in Associative Array1b. The input/mask register combination defines a gate type that will be activated for searching in Associative Array1a Words that successfully match are indicated in a 1-bit column register. The array also has write capabilties.

module Ary_1a(Input_reg1a,Mask_reg1a,Adr_reg1a,Clock,

Search_enbl1a,Write_enbl1a,Activ_lst1a);

```
// Input_reg1a, Mask_reg1a, Adr_reg1a are the Input,Mask and Address registers
  of Associative Array1a.
  When Search_enbl1a is set, the negative edge of Clock initiates a parallel
  search.
  Activ_lst1a is a column register that indicates those words in Associative
```

| | |
|---|---|
| Array1a which compared successfully with the search pattern. | // |

```
parameter Ary_1a_wdth=7;
parameter Ary1a_size=16383;
integer Ary_index;
input Clock,Search_enbl1a,Write_enbl1a;
input[Ary_1a_wdth:0] Input_reg1a, Mask_reg1a, Adr_reg1a;
output [Ary1a_size:0] Activ_lst1a;
reg [Ary1a_size:0] Activ_lst1a;
reg [Ary_1a_wdth:0] Ary1a_ass_mem[0:Ary1a_size], Temp_reg;
initial
  begin
  $readmemb(“Ary1a.dat”,Ary1a_ass_mem);
// Ary1a.dat is the data file defining the gate and model types in the circuit.//
  for (Ary_index=0; Ary_index<=Ary1a_size; Ary_index=Ary_index+1)
    begin
    Activ_lst1a[Ary_index]=0;
    end
  end
always @(negedge Clock)
begin
  if (Search_enbl1a)
  begin
  for (Ary_index=0; Ary_index<=Ary1a_size; Ary_index=Ary_index+1)
    begin
    Temp_reg=Ary1a_ass_mem[Ary_index];
    if ((˜Mask_reg1a | (Input_reg1a & Temp_reg) |
                                (˜Input_reg1a & ˜Temp_reg))==8′hff)
      Activ_lst1a[Ary_index]=1;
    else
      Activ_lst1a[Ary_index]=0;
    end
  end
  if (Write_enbl1a) Ary1a_ass_mem[Adr_reg1a]= Input_reg1a;
end
endmodule
```

Associative Array1b

Description: Every word in this array represents the temporal spread of signal values on a specific wire. The most recent values being leftmost in each word. All words can be simultaneously shifted right, effecting a one unit time increment on all wires. The signal values are updated from a 1-bit column register. The array has parallel search and read and write capabilities.

module Ary_1b ( Search_reg1b, Mask_reg1b, Adr_reg1b, Datain_reg1b,

Dataout_reg1b,Hit_buffr_reg1b, Shft_enbl, Search_enbl1b,
Write_enbl, Read_enbl,Clock,Input_bit,
Word_line_enbl);

// Search_reg1b, Mask_reg1b, Adr_reg1b, Datain_reg1b,Dataout_reg1b are the
Search,Mask, Address,Data-in and data-out registers of Associative Array1b.
When Search_enbl1b is set, the negative edge of Clock initiates a parallel
search. Likewise, a read or write operation is executed on the negative edge of
the clock if Write_enbl or Read_enbl is asserted.
A parallel search is initiated on a negative edge of the Clock if Search_enbl1b is
set. This search is only active on those words that are primed for searching by
the Word_line_enbl column regsiter. The bits in this register are set/cleared by
Activ_lst1a of Associative Array1a. This effectively selects gates of a certain
gate type and delay model. Words that match are identified by bit being set in the
corresponding position in Hit_buffr_reg1b.
Words are shifted right in parallel with the leftmost bit being taken from
Input_bit.//
parameter Ary1b_mem_size=16383;
parameter Wlr_wrdsize =31;
parameter Shft_dly=2;
parameter Adr_reg_bits=13;
input[Wlr_wrdsize:0] Search_reg1b, Mask_reg1b, Datain_reg1b;
input[Ary1b_mem_size:0] Input_bit,Word_line_enbl;

| | |
|---|---|
| input | Clock; |
| input | Shft_enbl,Search_enbl1b,Write_enbl,Read_enbl; |

reg [Wlr_wrdsize:0] Temp_reg1;
reg [Wlr_wrdsize:0] Wlr_Ass_mem[0:Ary1b_mem_size];
input [Adr_reg_bits:0] Adr_reg1b;

| | |
|---|---|
| output | [Ary1b_men_size:0] Hit_buffr_reg1b; |
| reg | [Ary1b_mem_size:0] Hit_buffr_reg1b; |
| output | [Wlr_wrdsize:0] Dataout_reg1b; |
| reg | [Wlr_wrdsize:0] Dataout_reg1b; |

```
integer Mem_indx;
initial $readmemb(“Array1b.dat”,Wlr_Ass_mem);
//Array1b.dat is the file which initialises all the words in Arrray1b to the
Unknown value.//
always @(negedge Clock)
  begin
  if (Shft_enbl)
  begin
    for (Mem_indx=0; Mem_indx<=Ary1b _mem_size ; Mem_indx= Mem_indx + 1)
      begin
        Temp_reg1 = Wlr_Ass_mem[Mem_indx];
        Temp_reg1= Temp_reg1 >> 1;
        Temp_reg1[Wlr_wrdsize] = Input_bit[Mem_indx];
        Wlr_Ass_mem[Mem_indx] = Temp_reg1;
      end
    end
    else
    if (Search_enbl1b)
    begin
    far (Mem_indx=0; Mem_indx<=Ary1b_mem_size ; Mem_indx = Mem_indx + 1)
      begin
      if (Word_line_enbl[Mem_indx])
      begin
        Temp_reg1 = Wlr_Ass_mem [Mem_indx];
        if ((˜Mask_reg1b | (Search_reg1b & Temp_reg1) |
              (˜Search_reg1b & ˜Temp_reg1))==32′hffffffff)
        begin
        Hit_buffr_reg1b[Mem_indx] = 1;
        end
        else
        begin
        Hit_buffr_reg1b[Mem_indx] = 0;
        end
      end
      else
      Hit_buffr_reg1b[Mem_indx] = 0;
      end
    end
    else
    if (Write_enbl)
        Wlr_Ass_mem[Adr_reg1b] = Datain_reg1b;
    else
    if (Read_enbl)
        Dataout_reg1b = Wlr_Ass_mem[Adr_reg1b];
  end
endmodule
```

Test-Result Register Bank

Description: When an i^{th} search is executed on Associative Array1b, if wordⱼ in Array1b matches the search pattern, then bitᵢ in wordⱼ of the Test-result register bank will be set, otherwise it is cleared. The Result-activator register specifies the logical combination between pairs of words (a gate's set of inputs). The result of this combination of word pairs is a column register (half the length of the number of word pairs).

module Tst_rslt_reg_bank(Inp_buffr_reg,Trr_wrt_enbl,Comb_enbl,Clock,

Out_buffr_reg,Rslt_act_reg,Write_pos,Rset);

// Inp_buffr_reg is a column of bits describing the outcome of a search on each
word in Array1b. This bit column is written into a column of the Test-result
register bank on the negative edge of Clock when Trr_wrt_enbl is asserted. The
position of this coulmn is defined by Write_pos.
Word pairs are combined according to the bit sequence in Rslt_act_reg. A ‘0’ in
bitᵢ of Rslt_act_reg ORs the i^{th} bits in each word pair and produces the result for
each pair in Out_buffr_reg. This combination is executed on the negative edge of
Clock when Comb_enbl is asserted. Rset resets all the bits in the Test-result
register bank.//
parameter Trr_word_size=7;
parameter Trr_mem_size=16383;
parameter Trr_out_size=8191;
parameter Trr_wdth_spec=2;
reg[Trr_word_size:0] Trr_array[0:Trr_mem_size];
reg[Trr_word_size:0] Temp_reg1, Temp_reg2;
reg Rslt_action;
input [Trr_mem_size:0] Inp_buffr_reg;
input [Trr_word_size:0] Rslt_act_reg;
input [Trr_wdth_spec:0] Write_pos;
input Clock;
input Trr_wrt_enbl;
input Comb_enbl;
input Rset;

| | |
|---|---|
| output [Trr_out_size:0] | Out_buffr_reg; |
| reg[Trr_out_size:0] | Out_buffr_reg; |
| integer Bank_index,i; | |

```
always @(negedge Clock)
  begin
    if (Trr_wrt_enbl)
      begin
      for (Bank_index=0; Bank_index<=Trr_mem_size; Bank_index=Bank_index+1)
        begin
        Temp_reg1=Trr_array[Bank_index];
        Temp_reg1[Write_pos]=Inp_buffr_reg[Bank_index];
        Trr_array[Bank_index]=Temp_reg1;
        end
      end
      else
    if (Comb_enbl)
      begin
      Rslt_action=Rslt_act_reg[Write_pos];
      for (i=0; i<=Trr_word_size; i=i+1)
      begin
        for(Bank_index=0;Bank_index<Trr_mem_size;Bank_index=Bank_index+2)
        begin
        Temp_reg1=Trr_array[Bank_index];
        Temp_reg2=Trr_array[Bank_index+1];
        if (Rslt_action==0)
        Out_buffr_reg[Bank_index/2]=(Temp_reg1[Write_pos] |
```

Temp_reg2[Write_pos]);

```
        else
        Out_buffr_reg[Bank_index/2]=Temp_reg1[Write_pos] &
```

Temp_reg2[Write_pos];

```
        end
      end
    end
    else
    if (Rset)
      begin
        for(Bank_index=0;Bank_index<=Trr_mem_size;Bank_index=Bank_index+1)
          Trr_array[Bank_index]=8′h00;
      end
  end
endmodule
```

Group-Result Register Bank

Description: The result of the combination of word pairs in the Test-result register is written as a column of bits into the Group-result register bank. When all combination results have been generated a parallel search is executed on the Group-result register to ascertain all word pairs in Array1b that passed all the test pattern searches.

module Grp_rslt_reg_bank(Grr_inp_reg,Grr_mask_reg,Grr_srch_reg,

Clock,Srch_enbl,Wrt_enbl,Write_pos,
Grr_hit_list);

// Grr_inp_reg is shifted as a bit column into a column of the Group-result
register bank defined by Write_pos. This column write operation is activated on
the negative edge of Clock when Wrt_enbl is asserted.
Grr_mask_rog and Grr_srch_reg compose a search pattern enacted on the negative
edge of Clock when Srch_enbl is set. Pattern matches are indicated in
Grr_hit_list. The Grr_hit_list is also known as the Group-test Hit list.//
parameter Grr_mem_size=8191;
parameter Grr_word_size=7;
parameter Grr_wdth_spec=2;
input [Grr_mem_size:0] Grr_inp_reg;
input [Grr_word_size:0] Grr_mask_reg,Grr_srch_reg;
input [Grr_wdth_spec:0] Write_pos;
input Clock,Srch_enbl,Wrt_enbl;

| | |
|---|---|
| output | [Grr_mem_size:0] Grr_hit_list; |
| reg | [Grr_mem_size:0] Grr_hit_list; |

```
reg [Grr_word_size:0] Grr_array[0:Grr_mem_size];
reg [Grr_word_size:0] Temp_reg;
integer Bank_index;
always @(negedge Clock)
            if (Wrt_enbl)
              begin
              for (Bank_index=0; Bank_index<=Grr_mem_size;
```

Bank_index=Bank_index + 1)

```
              begin
                Temp_reg= Grr_array[Bank_index];
                Temp_reg[Write_pos]= Grr_inp_reg[Bank_index];
                Grr_array[Bank_index]=Temp_reg;
              end
              end
            else if (Srch_enbl)
              for (Bank_index=0;Bank_index<=Grr_mem_size:
```

Bank_index=Bank_index+1)

```
              begin
              Temp_reg = Grr_array[Bank_index];
              if ((-Grr_mask_reg | (Grr_srch_reg & Temp_reg) |
                      (-Grr_srch_reg & -Temp_reg))==8′hff)
                Grr_hit_list[Bank_index] = 1;
              else
                Grr_hit_list[Bank_index] = 0;
            end
endmodule
```

Multiple-Response Resolver (Version 1.0 Single Scan Mode)

Description: The Multiple-response resolver scans the Group-test Hit list (a 1-bit column register). The resolver commences a scan by initialising its counter with the top address of the Hit list. This counter serves as an address register which facilitates reading of every Hit list bit. If the inspected bit is set, the fan-out list of the associated gate is accessed and updated appropriately. The bit is then reset. After reset or if the bit was already zero, the counter is decremented to point to the next address in the Hit list. The inspection process is repeated. The scanning terminates either when all bits have been inspected or all bits are zero.

module Multiple_res_res(Grr_hit_list,Clock,

Reset_ctr,End_scan_flag,Decrmt_enbl,
Fan_out_src_reg,Fan_out_size_reg,Rset_hit_fnd_flg,
Hit_fnd_flag);

```
// The Multiple_response_resolver inspects a new bit of Grr_hit_list on the
negative edge of Clock while Decrmt_enbl is asserted. Reset_ctr loads the
resolver's counter with top location of Hit list. If the current inspected bit is
set. Hit_fnd_flag is asserted and the vector and the size (no. of gates) for the
fan-out list loaded into Fan_out_src_reg and Fan_out_size_reg, respectively.
Scanning halts and only recommences on the positive edge of Rsat_hit_fnd_flg which
is externally controlled. Scanning terminates when all bits have been inspected or
reset to zero. This condition is indicated by End_scan_flag.//
parameter Grr_mem_size=8191;
parameter Vectr_tbl_adr_reg_bits=13;
parameter Fanout_hdr_tbl_wdth=13;
parameter Max_fan_out=7;
parameter Inp_bnk_size=16383;
input Reset_ctr,Rset_hit_fnd_flg,Clock;
input Grr_mem_size:0] Grr_hit_list;
input Decrmt_enbl;
output End_scan_flag;
reg End_scan_flag;
output Hit_fnd_flag;
reg Hit_fnd_flag;
output Fan_out_src_reg;
reg[Vectr_tbl_adr_reg_bits:0] Fan_out_src_reg;
output Fan_out_size_reg;
reg[Max_fan_out:0] Fan_out_size_reg;
reg[Fanout_hdr_tbl_wdth:0] Fan_out_hdr_tbl[0:Inp_bnk_size];
reg[Vectr_tbl_adr_reg_bits:0] Hit_lst_ctr;
reg[Max_fan_out:0] Fan_out_size_tbl[0:Inp_bnk_size];
reg[Grr_mem_size:0] Hit_lst_buffr;
reg Hit_fnd_ORed_flg,Tst_or_bit;
integer Num_hits,Hit_dist,Sum_hit_dist,Prev_hit_lst_ctr,Avg_dist;
initial $readmemh(“Fanout.dat”, Fan_out_hdr_tbl);
//The file Fanout.dat contains the vectors for the start of the fan-out lists for
every gate in the circuit being simulated.//
initial $readmemh(“Fansize.dat”,Fan_out_size_tbl);
//The file Fansize.dat specifies the size of the fan-out list for each gate being
simulated.//
initial forever
begin
  @(Reset_ctr)
  if (Reset_ctr)
  begin
  Num_hits=0;
  Prev_hit_lst_ctr=Grr_mem_size;
  Sum_hit_dist=0;
  Hit_lst_buffr=Grr_hit_list;
  Tst_or_bit=|Grr_hit_list;
  $display(“OR Check=%b”,Tst_or_bit);
  Hit_lst_ctr=Grr_mem_size;
  End_scan_flag=0;
  Hit_fnd_flag=0;
  Hit_fnd_ORed_flg=1;
  $display(“Initialisation seq executed”);
  end
end
always @(negedge Clock)
  begin
  if ((Decrmt_enbl) && (! End_scan_flag))
    begin
    Hit_fnd_ORed_flg=|Hit_lst_buffr;
    if ((Hit_lst_ctr>0) && ( Hit_fnd_ORed_flg))
      begin
        if (Hit_lst_buffr[Hit_lst_ctr]==1)
        begin
        Num_hits=Num_hits + 1;
        Hit_dist=Prev_hit_lst_ctr − Hit_lst_ctr;
        Sum_hit_dist=Hit_dist+Sum_hit_dist;
        $display(“Hit distance=%d”,Hit_dist,“Time=%d”,$time);
        Prev_hit_lst_ctr=Hit_lst_ctr;
        Fan_out_size_reg=Fan_out_size_tbl[Hit_lst_ctr];
        Fan_out_src_reg=Fan_out_hdr_tbl[Hit_lst_ctr];
        Hit_fnd_flag=1;
        Hit_lst_buffr[Hit_lst_ctr]=0;
        end
      end
    if ((Hit_lst_ctr>0) && (! Hit_fnd_ORed_flg))
      begin
        End_scan_flag=1;
        $display(“No of hits in fan-out list=%d”,Num_hits);
        Avg_dist=Sum_hit_dist/Num_hits;
        $display(“Average hit distance=%d”,Avg_dist);
      end
    if (Hit_lst_ctr==0)
      begin
        if (Hit_lst_buffr[Hit_lst_ctr]==1)
          begin
          Num_hits=Num_hits + 1;
          Hit_dist=Prev_hit_lst_ctr−Hit_lst_ctr;
          $display(“Hit distance=%d”,Hit_dist);
          Prev_hit_lst_ctr=Hit_lst_ctr;
          Sum_hit_dist=Hit_dist+Sum_hit_dist;
          Fan_out_size_reg=Fan_out_size_tbl[Hit_lst_ctr];
          Fan_out_src_reg=Fan_out_hdr_tbl[Hit_lst_ctr];
          Hit_fnd_flag=1;
          end
        End_scan_flag=1;
        $display(“No of hits in fan-out list=%d”,Num_hits);
        Avg_dist=Sum_hit_dist/Num_hits;
        $display(“Average hit distance=%d”,Avg_dist);
      end
    Hit_lst_ctr=Hit_lst_ctr −1;
    end
  end
always @(posedge Rset_hit_fnd_flg)
  begin
  Hit_fnd_flag=0;
  end
endmodule
```

Multiple_Response Resolver (Version 2.0 Multiple Scan Mode)

Description: The Multiple-response resolver scans the Group-test Hit list (a 1-bit column register). The resolver in Multiple Scan Mode consists of several counter(scan) registers. Each is assigned an equal size portion of the Group-test Hit list. When the resolver is initialised all scan registers point to the top of their respective Hit list segment. The registers are synchronised by a single clock. The external functionality of the Multiple Scan Mode resolver is identical to that of the Single Scan Mode version. Internally, the Multiple Scan version uses a Wait semaphore to queue multiple accesses to the fan-out lists. Registers which clash are queued arbitrarily and only recommence scanning after gaining permission to update their fan-out lists. Scanning terminates when all bits have been inspected or all bits are zero.

module Multiple_res_res(Grr_hit_list,Clk,

Reset_ctr,End_scan_flag,Decrmt_enbl.
Fan_out_src_reg,Fan_out_size_reg,Rset_hit_fnd_flg,
Hit_fnd_flag);

```
// The Multiple_response_resolver inspects in parallel several bits of
Grr_hit_list on the negative edge of Clock while Decrmt_enbl is asserted.
Reset_ctr loads the resolver's scan registers with the top location of each
respective segment of the Hit list. If any of the current inspected bits are set,
Hit_fnd_flag is asserted. The vector and the size (no. of gates) for the fan-out
list of the segment which has been granted permission, is loaded into
Fan_out_src_reg and Fan_out_size_reg, respectively. Scanning halts for all
registers awaiting permission. Permission is arbitrarily granted to a segment on
the positive edge of Rset_hit_fnd_flg which is externally controlled. For
registers that have not found a hit, a new bit is inspected on the negative edge
of Clock. Scanning terminates when all bits have been inspected or reset to zero.
This condition is indicated by End_scan_flag.//
parameter Grr_mem_size=8191;
parameter Vectr_tbl_adr_reg_bits=13;
parameter Fanout_hdr_tbl_wdth=13;
parameter Max_fan_out=7;
parameter Inp_bnk_size=16383;
input Reset_ctr,Rset_hit_fnd_flg,Clk;
input[Grr_mem_size:0] Grr_hit_list;
input Decrmt_enbl;
output End_scan_flag;
reg End_scan_flag;
output Hit_fnd_flag;
reg Hit_fnd_flag;
output Fan_out_src_reg;
reg[Vectr_tbl_adr_reg_bits:0] Fan_out_src_reg;
output Fan_out_size_reg;
reg[Max_fan_out:0] Fan_out_size_reg;
reg[Fanout_ndr_tbl_wdth:0] Fan_out_hdr_tbl[0:Inp_bnk_size];
reg[Max_fan_out:0] Fan_out_size_tbl[0:Inp_bnk_size];
reg[Grr_mem_size:0] Hit_lst_buffr;
reg Hit_fnd_ORed_flg,Tst_or_bit,Mpl_scan_enbl;
integer Num_hits,Num_hits_ratio,Start_time,Finish_time;
reg decrmt_enbl1,decrmt_enbl2,decrmt_enbl3,decrmt_enbl4,mem_access;
reg decrmt_enbl5,decrmt_enbl6,decrmt_enbl7,decrmt_enbl8;
---------------------------------------------------------
reg decrmt_enbl25,decrmt_enbl26,decrmt_enbl27,decrmt_enbl28;
reg decrmt_enbl29,decrmt_enbl30;
//These registers enable a segment to be scanned when asserted. This program
assumes that the list is divided into 30 equalled size segments.//
integer c1,c2,c3,c4,c5,c6,c7,c8;
------------------------------
integer c25,c26,c27,c28,c29,c30,Total;
reg[Vectr_tbl_adr_reg_bits:0] pos1,pos2,pos3,pos4,pos5,pos6,pos7,pos8;
-------------------------------------------------------------------
reg[Vectr_tbl_adr_reg_bits:0] pos25,pos26,pos27,pos28,pos29,pos30;
// These are the scan registers for each segment.//
parameter upr_lt1= 149;
parameter lwr_lt1= 0;
parameter upr_lt2= 299;
parameter lwr_lt2= 150;
parameter upr_lt3= 449;
parameter lwr_lt3= 300;
parameter upr_lt4= 599;
parameter lwr_lt4= 450;
parameter upr_lt5= 749;
parameter lwr_lt5= 600;
parameter upr_lt6= 899;
parameter lwr_lt6= 750;
-------------------------
parameter upr_lt27= 4049;
parameter lwr_lt27= 3900;
parameter upr_lt28= 4199;
parameter lwr_lt28= 4050;
parameter upr_lt29= 4349;
parameter lwr_lt29= 4200;
parameter upr_lt30= 4392;
parameter lwr_lt30= 4350;
// These parameters define the upper and lower limits of the segments of the
Group-test Hit list.//
initial
  begin
    pos1=upr_lt1;
    pos2=upr_lt2;
    pos3=upr_lt3;
    pos4=upr_lt4;
    pos5=upr_lt5;
    pos6=upr_lt6;
    --------------
    pos27=upr_lt27;
    pos28=upr_lt28;
    pos29=upr_lt29;
    pos30=upr_lt30;
    decrmt_enbl1=1;
    decrmt_enbl2=1;
    decrmt_enbl3=1;
    decrmt_enbl4=1;
    decrmt_enbl5=1;
    decrmt_enbl6=1;
    decrmt_enbl7=1;
    ---------------
    decrmt_enbl27=1;
    decrmt_enbl28=1;
    decrmt_enbl29=1;
    decrmt_enbl30=1;
    c1=0;
    c2=0;
    c3=0;
    c4=0;
    c5=0;
    c6=0;
    -----
    c27=0;
    c28=0;
    c29=0;
    c30=0;
    mem_access=1;
  end
initial $readmemh(“Fanout.dat”, Fan_out_hdr_tbl);
//The file Fanout.dat contains the vectors for the start of the fan-out lists for
every gate in the circuit being simulated.//
initial $readmemh(“Fansize.dat”,Fan_out_size_tbl);
//The file Fansize.dat specifies the size of the fan-out list for each gate being
simulated.//
initial forever
begin
  @(Reset_ctr)
  if (Reset_ctr)
    begin
    Num_hits=0;
    Hit_lst_buffr=Grr_hit_list;
    Tst_or_bit=|Grr_hit_list;
    $display(“OR Check=%b”,Tst_or_bit);
    End_scan_flag=0;
    Hit_fnd_flag=0;
    Hit_fnd_ORed_flg=1;
    pos1=upr_lt1;
    pos2=upr_lt2;
    pos3=upr_lt3;
    pos4=upr_lt4;
    pos5=upr_lt5;
    pos6=upr_lt6;
    --------------
    pos27=upr_lt27;
    pos28=upr_lt26;
    pos29=upr_lt29;
    pos30=upr_lt30;
    decrmt_enbl1=1;
    decrmt_enbl2=1;
    decrmt_enbl3=1;
    decrmt_enbl4=1;
    decrmt_enbl5=1;
    decrmt_enbl6=1;
    --------------
    decrmt_enbl27=1;
    decrmt_enbl28=1;
    decrmt_enbl29=1;
    decrmt_enbl30=1;
    c1=0;
    c2=0;
    c3=0;
    c4=0;
    c5=0;
    c6=0;
    -----
    c27=0;
    c28=0;
    c29=0;
    c30=0;
    mem_access=1;
    mem_access=1;
    $display(“Initialisation seq executed”);
    Start_time=$time;
    end
end
always @(posedge Decrmt_enbl)
    begin
      Mpl_scan_enbl=1;
    end
always @(posedge Rset_hit_fnd_flg)
    begin
    Hit_fnd_flag=0;
    mem_access=1;
    end
always @ (negedge Clk)
  begin
    if (! End_scan_flag)
      begin
      Hit_fnd_ORed_flg=|Hit_lst_buffr;
      if (! Hit_fnd_ORed_flg)
      begin
      End_scan_flag=1;
      Mpl_scan_enbl=0;.
      end
      end
    if ((Mpl_scan_enbl) && ( Hit_fnd_ORed_flg))
      begin
      if (decrmt_enbl1)
        begin
          if (Hit_lst buffr[pos1]==1)
            begin
              Hit_lst_buffr[pos1]=0;
              decrmt_enbl1=0;
              if (!mem_access )
                begin
                c1=c1+1;
                $display(”Clash1 c1=%d”,c1);
                end
              wait(mem_access);
              mem_access=0;
              Num_hits=Num_hits + 1;
              Fan_out_size_reg=Fan_out_size_tbl[pos1];
              Fan_out_src_reg=Fan_out_hdr_tbl[pos1];
              Hit_fnd_flag=1;
              Hit_lst_buffr[pos1]=0;
              if (pos1 >lwr_lt1)
                begin
                pos1=pos1−1;
                decrmt_enbl1=1;
                end
            end
        else
          begin
                if (pos1 >lwr_lt1)
                begin
                pos1=pos1−1;
                end
                else
                decrmt_enbl1=0;
          end
      end
    ---------------------
    if (decrmt_enbl30)
      begin
        if (Hit_lst_buffr[pos30]==1)
            begin
              Hit_lst_buffr[pos30]=0;
              decrmt_enbl30=0;
              if (!mem_access )
                begin
                c30=c30+1;
                $display(“Clash30 c30=%d”,c30);
                end
              wait(mem_access);
              mem_access=0;
              Num_hits=Num_hits + 1;
              Fan_out_size_reg=Fan_out_size_tbl[pos30];
              Fan_out_src_reg=Fan_out_hdr_tbl[pos30];
              Hit_fnd_flag=1;
              Hit_lst_buffr[pos30]=0;
              if (pos30 >lwr_lt30)
                begin
                pos30=pos30−1;
                decrmt_enbl30=1;
                end
              end
        else
            begin
                if (pos30 >lwr_lt30)
                begin
                pos30=pos30−1;
                end
                else
                decrmt_enbl30=0;
            end
      end
  end
  end
always @(posedge End_scan_flag)
  begin
  Finish_time=$time;
  end
endmodule
```

Fan-Out Generator Module

Description: When a hit has been detected in the Group-test Hit list. The address within the scan register selects a vector (from the Fan-out hdr table) which locates the start of a fan-out list for the current active gate. The address register of this module is loaded with the address of the header of the fan-out list. The size of this fan-out list and the updated signal value to be transmitted is also conveyed to the module. The module proceeds to affect all changes in the fan-out lists.

module_Fan_out_gen(Fan_out_load,Fan_out_gen_flg,Reset_gen,Update_val_in,

Clock,Update_val_out,Fan_out_size_reg,
Fan_out_adr_reg,Out_adr_reg);

```
//The address in Fan_out_vector_tbl of the header of the Fan-out list and the
number of fan-out elements, are contained in Fan_out_adr_reg and Fan_out_size_reg
respectively. These are loaded on the positive edge of Fan_out_load. On the
successive negative edge(s) of Clock the address of a fan-out wire is generated in
Out_adr_reg. The end of a fan-out list is indicated when Fan_out_gen_flg is set.
This flag is cleared by the positive edge of Reset_gen. The signal value to be
conveyed to the fan-out list is transferred to and transmitted by the module in
Update_val_in and Update_val_out, respectively.//
parameter Vectr_tbl_wrd_size = 13;
parameter Vectr_tbl_size = 16383;
parameter Inp_val_wdth=2;
parameter Max_fan_out=7;
parameter Vectr_tbl_adr_size=13;
input Fan_out_load,Reset_gen,Clock;
input [Inp_val_wdth:0] Update_val_in;
input [Max_fan_out:0] Fan_out_size_reg;
input [Vectr_tbl_adr_size:0] Fan_out_adr_reg;
output Fan_out_gen_flg;
reg Fan_out_gen_flg;
output [Inp_val_wdth:0] Update_val_out;
reg [Inp_val_wdth:0] Update_val_out;
output [Vectr_tbl_wrd_size:0] Out_adr_reg;
reg [Vectr_tbl_wrd_size:0] Out_adr_reg;
reg[Vectr_tbl_wrd_size:0] Fan_out_vector_tbl [0:Vectr_tbl_size];
reg[Vectr_tbl_wrd_size:0] List_pos;
reg[Max_fan_out:0] Counter;
initial $readmemh(“Fanvcr.dat”, Fan_out_vector_tbl);
//Fanvcr.dat contains the vectors of the signals in the fan-out lists for every
gate.//
initial forever
begin
  @(Reset_gen)
  if (Reset_gen)
    begin
    Fan_out_gen_flg=0;
    end
end
always @(posedge Fan_out_load)
  begin
  if (!Reset_gen)
  begin
  Counter=Fan_out_size_reg;
  List_pos=Fan_out_adr_reg;
  Update_val_out=Update_val_in;
  Fan_out_gen_flg=1;
  end
  end
always @(negedge Clock)
  begin
  if (!Reset_gen && Fan_out_gen_flg)
  begin
  if (Counter>0)
    begin
    Out_adr_reg=Fan_out_vector_tbl[List_pos];
    List_pos=List_pos+1;
    Counter=Counter−1;
    end
  else
    Fan_out_gen_flg=0;
  end
  end
endmodule
```

Input-Value Bank

Description: The bank contains the current values of all the signals in the circuit. Each location in the bank corresponds to a wire. Since a word at any location is 3 bits wide, up to 8-valued logic can be simulated (this can be augmented by increasing the word width). The current value of any wire is shifted from this bank into Array_1b when time is incremented. This is done in parallel. Only wire values that have changed in the current time interval are updated.

module Input_val_bank(Inp_val_reg, Adr_reg,Clock, Shft_enbl,Wrt_enbl,

Out_buffr_reg);

```
//Inp_val_reg contains the new value of a signal(i.e. word) in Inp_val_ary. The
location of the wire is specified in Adr_reg and the write operation takes effect
on the negative edge of Clock if Wrt_enbl is asserted. If Shft_enbl is asserted
then the right-most bit of every location is shifted into the 1-bit column-
register Out_buffr_reg on the positive edge of Clock. All shifted bits are also
written into the right-most bit of Inp_val_ary (i.e a rotation); thus all current
values have been retained after the shifting out process. //
parameter Inp_val_wdth=2;
parameter Adr_reg_bits=13;
parameter Inp_bnk_size=16383;
parameter Lsr7552_Inp_bnk_size=8784;
input Clock,Shft_enbl,Wrt_enbl;
input[Inp_val_wdth: 0] Inp_val_reg;
input[Adr_reg_bits:0] Adr_reg;
output[Inp_bnk_size:0] Out_buffr_reg;
reg [Inp_bnk_size:0] Out_buffr_reg;
reg [Inp_val_wdth:0] Inp_val_ary[0: Inp_bnk_size];
reg [Inp_val_wdth:0] Temp_reg;
reg Temp_bit;
integer Inp_ary_indx,i;
initial $readmemb(“Inpval.dat”,Inp_val_ary);
//Inpval.dat is the file which initialises the current input values of all gates
in the simulated circuit. All values are assigned ‘Unknown’ logic values except
those primary inputs which are assigned logic ‘0’ or ‘1’.//
always @(posedge Clock)
  begin
    if (Shft_enbl)
    begin
      for (Inp_ary_indx=0; Inp_ary_indx<=Lsr7552_Inp_bnk_size;
                                              Inp_ary_indx=Inp_ary_indx+1)
      begin
        Temp_reg=Inp_val_ary_[Inp_ary_indx];
        Temp_bit=Temp_reg[0];
        Out_buffr_reg[Inp_ary_indx]=Temp_bit;
        Temp_reg[1:0]=Temp_reg[Inp_val_wdth:1];
        Temp_reg[Inp_val_wdth]=Temp_bit;
        Inp_val_ary[Inp_ary_indx]=Temp_reg;
      end
      $display(“(Shft)time=%d”,$time);
    end
    else
    if (Wrt_enbl)
      begin
      Inp_val_ary[Adr_reg]=Inp_val_reg;
      end
  end
endmodule
```

The Sequence Logic of the APPLES Processor

```
parameter Nibl=3;
parameter Ary_1a_wdth=7;
parameter Ary_1b_adr_reg_wdth=13;
parameter Ary_1a_size=16383;
parameter Ary_1b_size=16383;
parameter Eval_ptrn_tbl_size=63;
parameter Eval_ptrn_vctr_tbl_size=31;
parameter Num_tst_wdth=7;
parameter Num_tst_ptrn_tbl_size=31;
parameter Gate_maskla_tbl_size=31;
parameter Gate_inptla_tbl_size=31;
parameter Trr_ptrn_tbl_size=31;
parameter Grr_ptrn_tbl_size=31;
parameter Out_val_tbl_size=31;
parameter Wlr_wrdsize=31;
parameter Trr_wdth_spec=2;
parameter Trr_word_size=7;
parameter Grr_mem_size=8191;
parameter Grr_wdth_spec=2;
parameter Grr_word_size=7;
parameter Iu_word_size=7;
parameter Iu_wdth_spec=2;
parameter Vectr_tbl_adr_reg=13;
parameter Max_fan_out=7;
parameter Inp_val_wdth=2;
parameter Vectr_tbl_adr_size=1639;
parameter Index_reg_wdth=7;
parameter Num_tst_seq=12; //No of gates X No Transitions
parameter Num_tst_cnt_wdth=3;
parameter Init_shft_val=3;
parameter Shft_cnt_wdth=3;
wire Clock;
wire[Ary_la_size:0] Wrd_ln_activ_lst,Trr_bnk_inp_reg;
wire[Ary_1b_size:0] Inval_unit_out_reg;
wire[Grr_mem_size:0] Grr_bnk_inp_reg,Grr_bnk_hit_lst;
wire[Max_fan_out:0] Mrr_unit_fan_out_size_reg;
wire[Vectr_tbl_adr_reg:0] Mrr_unit_fan_out_src_reg;
wire[Inp_val_wdth:0] Fo_gen_unit_val_out;
wire[Vectr_tbl_adr_size:0] Fo_gen_unit_out_adr_reg;
reg Tst_seq_strt;
reg e0,e1,e2,e3,e4,e5,e6,e7,e8,e9,e10,e11,e12,e13,e14,
    e15,e16,e16a,e16b,e17,e18,e19,e20,e21,e22,e23,e24,e25,e26,e27,e28,e29,
    Deact_srchla,Gate_eval_init_proc;
```

| | |
|---|---|
| reg[Index_reg_wdth: 0] | Ept_i,Epvt_i,Ntpt_i,Gmlat_i,Gilat_i, |
| | Tpt_i,Grit_i,Grmt_i,OVt_i; |

| | |
|---|---|
| reg[Wlr_wrdsize:0] | Eval_ptrn_tbl[0:Eval_ptrn_tbl_size]; |
| reg[Wlr_wrdsize:0] | Eval_ptrn_vctr_tbl[0:Eval_ptrn_vctr_tbl_size]; |
| reg[Num_tst_wdth:0] | Num_tst_ptrn_tbl[0:Num_tst_ptrn_tbl_size]; |
| reg[Ary_1a_wdth:0] | Gate_maskla_tbl[0:Gate_maskla_tbl_size]; |
| reg[Ary_1a_wdth:0] | Gate_inptla_tbl[0:Gate_inptla_tbl_size]; |

| | |
|---|---|
| reg[Trr_word_size:0] | Trr_ptrn_tbl[0:Trr_ptrn_tbl_size]; |
| reg[Grr_word_size:0] | Grr_Inpt_tbl[0:Grr_ptrn_tbl_size]; |
| reg[Grr_word_size:0] | Grr_mask_tbl[0:Grr_ptrn_tbl_size]; |
| reg[Inp_val_wdth:0] | Out_val_tbl[0:Out_val_tbl_size]; |
| reg[Grr_word_size:0] | Grr_bnk_search_reg,Grr_bnk_mask_reg; |
| reg[Grr_wdth_spec:0] | Grr_bnk_wrt_pos; |
| reg[Trr_wdth_spec:0] | Trr_bnk_wrt_pos; |
| reg[Trr_word_size:0] | Trr_rslt_act_reg,Trr_rslt_act_and_0; |

| | |
|---|---|
| reg[Iu_word_size:0] | Inval_unit_adr_reg; |
| reg[Iu_wdth_spec:0] | Fo_gen_unit_val_in,Inval_unit_in_reg; |

```
reg Search_ary_1a,Write_enbl_1a,Ary_1b_wrt_enbl,Wlr_bnk_search_enbl, Shft_ary_1b,
    Ary_1b_rd_enbl,Trr_bnk_wrt_enbl,Trr_bnk_comb_enbl,Trr_bnk_rset,
    Grr_bnk_search_enbl,Grr_bnk_wrt_enbl,Mrr_unit_rset,Mrr_unit_decrmt_enbl,
    Mrr_unit_rset_hit_fnd_flg,Fo_gen_unit_load,Fo_gen_unit_rset,
    Inval_unit_shft_enbl,Inval_unit_wrt_enbl;
reg[Ary_1a_wdth:0] Inp_regla, Mask_regla,Adr_regla;
reg[Wlr_wrdsize:0] Inp_reg_1b,Search_reg_1b,Mask_reg_1b;
reg[Ary_1b_adr_reg_wdth:0] Adr_reg_1b;
reg[Num_tst_cnt_wdth:0] Num_tst_cnt;
reg[Shft_cnt_wdth:0] Shft_cnt;
Ary_1a Gate_id_bnk(Inp_regla,Mask_regla,Adr_regla,Clock,
```

Search_ary_1a,Write_enbl_1a, Wrd_ln_activ_lst);

Ary_1b Wrd_ln_reg_bnk(Search_reg_1b, Mask_reg_1b,Adr_reg_1b,

Inp_reg_1b,Out_reg_1b,Trr_bnk_inp_reg,Shft_ary_1b,
Wlr_bnk_search_enbl,Ary_1b_wrt_enbl,Ary_1b_rd_enbl,
Clock,Inval_unit_out_reg,Wrd_ln_activ_lst);

Tst_rslt_reg_bank Trr_bnk(Trr_bnk_inp_reg,Trr_bnk_wrt_enbl,Trr_bnk_comb_enbl,

Clock, Grr_bnk_inp_reg,Trr_rslt_act_reg,
Trr_bnk_wrt_pos,Trr_bnk_rset);

Grp_rslt_reg_bank Grr_bnk(Grr_bnk_inp_reg,Grr_bnk_mask_reg,

Grr_bnk_search_reg,Clock,Grr_bnk_search_enbl,
Grr_bnk_wrt_enbl,Grr_bnk_wrt_pos,Grr_bnk_hit_lst);

Multiple_res_res Mrr_unit(Grr_bnk_hit_lst,Clock,Mrr_unit_rset,

Mrr_unit_end_scan_flg,Mrr_unit_decrmt_enbl,
Mrr_unit_fan_out_src_reg,
Mrr_unit_fan_out_size_reg,
Mrr_unit_rset_hit_fnd_flg,
Mrr_unit_hit_fnd_flag);

Fan_out_gen Fo_gen_unit(Fo_gen_unit_load,Fo_gen_unit_flg,Fo_gen_unit_rset,

Fo_gen_unit_val_in,Clock,Fo_gen_unit_val_out,
Mrr_unit_fan_out_size_reg,Mrr_unit_fan_out_src_reg,
Fo_gen_unit_out_adr_reg);

Input_val_bank Inval_unit(Fo_gen_unit_val_out,Fo_gen_unit_out_adr_reg,clock,

Inval_unit_shft_enbl,Inval_unit_wrt_enbl,
Inval_unit_out_reg);

```
Ck_gen  Clk_unit(Clock);
integer i,Tst_num,iter_cnt;
initial
  begin
    $display(“Initialisation commencing.”);
    $readmemb(“Ep_tbl.dat”,Eval_ptrn_tbl);
    $display(“Ep_tbl.dat loaded.”);
    $readmemh(“Epv_tbl.dat”,Eval_ptrn_vctr_tbl);
    $display(“Epv_tbl.dat loaded.”);
    $readmemh(“Ntp_tbl.dat”,Num_tst_ptrn_tbl);
    $display(“Ntp_tbl.dat loaded.”);
    $readmemb(“Gila_tbl.dat”,Gate_inptla_tbl);
    $display(“Gila_tbl.dat loaded.”);
    $readmemb(“Gmla_tbl.dat”,Gate_maskla_tbl);
    $display(“Gmla_tbl.dat loaded.”);
    $readmemb(“Tp_tbl.dat”,Trr_ptrn_tbl);
    $display(“Tp_tbl.dat loaded.”);
    $readmemb(“Gi_tbl.dat”,Grr_inpt_tbl);
    $display(“Gi_tbl.dat loaded.”);
    $display(“Gi_tbl.dat loaded.”);
    $readmemb(“Gm_tbl.dat”,Grr_mask_tbl);
    $display(“Gm_tbl.dat loaded.”);
    $readmemb(“Ov_tbl.dat”,Out_val_tbl);
    $display(“Ov_tbl.dat loaded.”);
    $display(“Table initialisation sequence completed”);
    Gate_eval_init_proc=1;
    iter_cnt=0;
    Num_tst_cnt=Num_tst_seq;
    Inval_unit_shft_enbl=0;
    Ept_i=8′h00; Epvt_i=8′h00; Ntpt_i=8′h00;
    Gmlat_i=8′h00; Gilat_i=8′h00; Tpt_i=8′h00;
    Grit_i=8′h00; Grmt_i=8′h00; Ovt_i=8′h00;
    end
    always @(negedge Clock)
    if (Gate_eval_init_proc)
      begin
      $display(“Gate_eval_init_proc @ time=%d”, $time);
      iter_cnt=iter_cnt+1;
      $display(“Iteration count=%d”,iter_cnt);
      Gate_eval_init_proc=0;
      Deact_srchla=0;
      e0=0; e1=0; e2=0; e3=0; e4=0; e5=0; e6=0;
      e7=0; e8=0; e9=0; e10=0; e11=0; e12=0; e13=0;
      e14=0; e15=0; e16=0; e16a=0; e16b=0; e17=0;
      e18=0; e19=0; e20=0; e21=0; e22=0;
      Inp_regla=Gate_inptla_tbl[Gilat_i];
      Mask_regla=Gate_maskla_tbl[Gmlat_i];
      Tst_num=Num_tst_ptrn_tbl[Ntpt_i];
      Ept_i=Eval_ptrn_vctr_tbl[Epvt_i];
      Mrr_unit_decrmt_enbl=0;
      Tst_seq_strt=1;
      wlr_bnk_search_enbl=0;
      Inval_unit_wrt_enbl=0;
      end
  always @(posedge Clock)
    begin
    if (Tst_seq_strt)
      begin
      Trr_bnk_rset=1;
      Search_ary_1a=1;
      e0=1;
      Tst_seq_strt=0;
      end
    end
  always @(negedge Clock)
    begin
    if (e0)
      begin
      e0=0;
      Deact_srchla=1;
      end
    end
  always @(posedge Clock)
    begin
    if (Deact_srchla)
      begin
      Trr_bnk_rset=0;
      Deact_srchla=0;
      Search_ary_1a=0;
      e1=1;
      i=Trr_word_size;
      end
    end
  always @(negedge Clock)
    begin
    if (e1)
      begin
      e1=0;
      e2=1;
      end
    end
  always @(posedge Clock)
    begin
    if (e2)
      begin
      Wlr_bnk_search_enbl=1;
      Search_reg_1b=Eval_ptrn_tbl[Ept_i];
      Mask_reg_1b=Eval_ptrn_tbl[Ept_i+1];
      e2=0;
      e3=1;
      end
    end
  always @(negedge Clock)
    begin
    if (e3)
      begin
      e3=0;
      e4=1;
      end
    end
  always @(posedge Clock)
    begin
    if (e4)
      begin
      Trr_bnk_wrt_enbl=1;
      Trr_bnk_wrt_pos=i;
      Wlr_bnk_search_enbl=0;
      e4=0;
      e5=1;
      end
    end
  always @(negedge Clock)
    begin
    if (e5)
      begin
      e5=0;
      e6=1;
      end
    end
  always @(posedge Clock)
    begin
      if (e6)
      begin
        Tst_num=Tst_num−1;
        i=i−1;
        e6=0;
        if (Tst_num> 0)
          begin
          e1=1;
          Ept_i=Ept_i+2;
          $display(“Ept_i (updated)=%d”,Ept_i);
          Trr_bnk_wrt_enbl=0;
          end
        else
          begin
          Trr_bnk_wrt_enbl=0;
          i=Trr_word_size;
          Trr_rslt_act_reg=Trr_ptrn_tbl[Tpt_i];
          Tst_num=Num_tst_ptrn_tbl[Ntpt_i];
          e7=1;
          end
      end
    end
  always @(negedge Clock)
    begin
    if (e7)
      begin
      e7=0;
      e8=1;
      end
    end
  always @(posedge Clock)
    begin
    if (e8)
      begin
      Trr_bnk_comb_enbl=1;
      Trr_bnk_wrt_pos=i;
      e8=0;
      e9=1;
      $display(“Commencement of TRR tests for Gate type=%b”,Inp_regla,“at
                  time=%d”,$time);
      end
    end
  always @(negedge Clock)
    begin
    if (e9)
      begin
      e9=0;
      e10=1;
      end
    end
  always @(posedge Clock)
      begin
      if (e10)
        begin
        Trr_bnk_comb_enbl=0;
        Grr_bnk_wrt_enbl=1;
        Grr_bnk_wrt_pos=i;
        e10=0;
        e11=1;
        end
      end
  always @(negedge Clock)
    begin
    if (e11)
      begin
      e11=0;
      e12=1;
    end
    end
  always @(posedge Clock)
      begin
      if (e12)
      begin
        Tst_num=Tst_num−1;
        i=i−1;
        e12=0;
        if (Tst_num>0)
          begin
          e9=1;
          Trr_bnk_comb_enbl=1;
          Trr_bnk_wrt_pos=i;
          Grr=bnk_wrt_enbl=0;
          end
        else
          begin
          e13=1;
          Grr_bnk_wrt_enbl=0;
          end
      end
      end
  always @(negedge Clock)
    begin
    if (e13)
      begin
      e13=0;
      e14=1;
      $display(“Termination of Trr tests for Gate type=%b”,Inp_regla,“at
                  time=%d”,$time);
      end
    end
  always @(posedge Clock)
    begin
    if (e14)
      begin
      Grr_bnk_search_reg=Grr_inpt_tbl[Grit_i];
      Grr_bnk_mask_reg=Grr_mask_tbl[Grmt_i];
      Grr_bnk_search_enbl=1;
      Fo_gen_unit_rset=1;
      e14=0;
      e15=1;
      end
    end
  always @(negedge Clock)
    begin
    if (e15)
      begin
      e15=0;
      e16=1;
      end
    end
  always @(posedge Clock)
    begin
    if (e16)
      begin
      Mrr_unit_rset=1;
      e16=0;
      e16a=1;
      end
    end
  always @(negedge Clock)
    begin
    if (e16a)
      begin
      Mrr_unit_rset=0;
      e16a=0;
      e16b=1;
      end
    end
  // Propagate values to gates affected in fan_out lists.
  always @(posedge Clock)
    begin
    if (e16b)
        begin
        Grr_bnk_search_enbl=0;
        Mrr_unit_decrmt_enbl=1;
        Fo_gen_unit_rset=0;
        Fo_gen_unit_Val_in=Out_val_tbl[Ovt_i];
        e16b=0;
        e17=1;
        $display(“Start of fanout list at time=%d”,$time);
        end
    end
  always @(negedge Clock)
    begin
    if (e17)
      begin
      Fo_gen_unit_load=0;
      e17=0;
      e18=1;
      end
    end
  always @(posedge Clock)
    begin
    if (e18)
      begin
        if (Mrr_unit_hit_fnd_flag)
            begin
            Fo_gen_unit_load=1;
            e18=0;
            e19=1;
            end
        else
      if((!Mrr_unit_hit_fnd_flag) & (Mrr_unit_end_scan_flg))
          begin
            e18=0;
            e22=1;
            Mrr_unit_decrmt_enbl=0;
          end
        end
    end
  always @(negedge Clock)
    begin
      if (e19)
      begin
        Fo_gen_unit_load=0;
        Inval_unit_wrt_enbl=1;
        Mrr_unit_rset_hit_fnd_flg=0;
        e19=0;
        e20=1;
      end
    end
  always @(posedge Clock)
    begin
      if (e20)
        begin
        if ( ! Fo_gen_unit_flg );
          begin
          if (! Mrr_unit_end_scan_flg)
            begin
            Mrr_unit_rset_hit_fnd_flg=1;
            Inval_unit_wrt_enbl=0;
            e20=0;
            e21=1;
            end
          else
            begin
            Inval_unit_wrt_enbl=0;
            e20=0;
            e22=1;
            end
          end
        end
    end
  always @(negedge Clock)
    begin
      if (e21)
        begin
        e18=1;
        e21=0;
        end
      end
  always @(negedge Clock)
    begin
      if (e22)
        begin
        e22=0;
        e23=1;
        Epvt_i=Epvt_i+1; Ntpt_i=Ntpt_i+1;
        Gmlat_i=Gmlat_i+1; Gilat_i=Gilat_i+1;
        Tpt_i=Tpt_i+1;
        Grit_i=Grit_i+1; Grmt_i=Grmt_i+1;
        Ovt_i=Ovt_i+1;
        $display(“Termination of Fan out update, time=%d”, $time);
      end
      end
  always @(posedge Clock)
    begin
      if (e23)
      begin
      e23=0;
      Num_tst_cnt=Num_tst_cnt−1;
        if (Num_tst_cnt==0)
        begin
        e24=1;
        end
      else
        Gate_eval_init_proc=1;
      end
    end
  always @(negedge Clock)
    begin
    if (e24)
    begin
      $display(“E24 attained,End of fanout update. ”);
      $display(“------------------------”);
      Inval_unit_shft_enbl=1;
      Shft_cnt=Init_shft_val;
    ‘e24=0;
      e25=1;
    end
    end
    // Input_val_bank is +ve edge triggered. Thus next block is −ve edge.
  always @(posedge Clock)
    begin
    if (e25)
      begin
      $display(“E25 attained ”);
      Shft_ary_1b=1;
      e25=0;
      e26=1;
      end
    end
  always @(negedge Clock)
    begin
    if(e26)
      begin
      $display(“E26 attained ”);
      Shft_cnt=Shft_cnt−1;
      if (Shft_cnt==0)
        begin
        e26=0;
        Inval_unit_shft_enbl=0;
        e27=1;
        end
      end
    end
  always @(posedge Clock)
    begin
      if (e27)
      begin
        Shft_ary_1b=0;
        e27=0;
        e28=1;
        end
    end
  always @(negedge Clock)
      begin
      if (e28)
        begin
        e28=0;
        e29=1;
        end
      end
  always @(posedge Clock)
    begin
    if (e29)
      begin
        Gate_eval_init_proc=1;
        Num_tst_cnt=Num_tst_seq;
        Ept_i=8′h00; Epvt_i=8′h00; Ntpt_i=8′h00;
        Gmlat_i=8′h00; Gilat_i=8′h00; Tpt_i=8′h00;
        Grit_i=8′h00; Grmt_i=8′h00; Ovt_i=8′h00;
        e29=0;
    end
    end
  endmodule
  @@@@@@@@@@@@@@@@@@@@@@@@@@@@
```

The APPLES architecture is designed to provide a fast and flexible mechanism for logic simulation. The technique of applying test patterns to an associative memory culminates in a fixed time gate processing and a flexible delay model. Multiple scan registers provide an effective way of parallelising the fan-out up-dating procedure. This mechanism eliminates the need for conventional parallel techniques such as load balancing and deadlock avoidance or recovery. Consequently, parallel overheads are reduced. As more scan registers are introduced, the gate evaluation rate increases, ultimately being limited by the average fan-out list size per gate and consequently the memory bandwidth of fan-out list memory.

Referring to FIG. 8, there is illustrated an array indicated generally by the reference numeral 20 comprising a plurality of cells 21, each of which comprises an APPLES processor as described above. A synchronisation logic control 22 is provided. The circuit that is to be simulated is split up among the APPLES processor. Gate evaluations are carried out independently in each processor or cell 21. Each cell 21 is provided with a local input value register bank and a foreign input value register bank to allow interconnection which is done through an interconnecting network 23 incorporating the synchronisation logic 22. Connections between the synchronisation logic circuit 22 which is, strictly speaking, the main synchronisation logic circuit, to each of the cells 21 is not shown.

After all gate evaluations for all gate types and the corresponding updates have occurred, on a given processor forming a cell 21, the processor must wait for all other processors to reach the same state. When all processors reach this state then the respective input value register banks can be shifted into the respective array and associative register 1b and evaluation of the next time unit can occur. Thus, to achieve implementation, there is required that a suitable interconnecting network must be designed and an interface to the APPLES processor constructed. A synchronisation method must exist to determine when evaluation of the next time unit should proceed. A system to split the hit list information amongst the processors is required in order to initialise the system.

The array of processors is implemented as a torus (equivalent to a 2D mesh with wrap-around) as shown in FIG. 8. The inclusion of wrap-around connections reduces the network diameter increasing the network speed. It also means that each processor can be identical without wasted hardware at the edges of the array. It does however require a more complicated routing mechanism. No set size was used for the array instead the size was used as a criteria which was varied during simulations. This criterion was specified by a command line parameter to the Verilog compiler. These command line parameters are covered in detail in the next chapter.

Each cell is connected to its four neighbouring cells via serial connections. Obviously parallel connections would be faster. However a Virtex FPGA was used and it has a limited number of pins. It may happen that not all of these pins are available to a particular design due to the FPGA architecture. Pins are therefore a precious resource. Since each FPGA would require eight parallel connections (an input and an output connection on each of the four edges) this would require a large number of pins. If at a later stage it is discovered that there are spare pins and a parallel network is justified then the design could be altered. In this design each cell has a serial input and a serial output on each of its four edges. These serial connections each consist of a data line and two control lines. These serial connections will therefore require 12 pins on each Virtex FPGA. Each cell is also connected to the array's synchronisation logic.

In order to design the network knowledge of the information that the network must carry is required. The network is required in order to pass fan out updates between processors. These updates can be passed as messages. Each message is an update and consists of a destination address and an update value. A single Virtex FPGA was used to implement an APPLES processor capable of simulating a circuit with approximately 256 gates. This figure is somewhat arbitrary and further design work will reveal the true value required. Given a restraint of 256 gates per processor approximately 64 processors would be required to simulate a reasonably complex circuit. This corresponded to an 8×8 array. Each processor will need to be able to send updates to any other processor updating any one of their 512 gate inputs. This implies an address space of six to identify the processor and an address space of nine to identify the wire. Each update sent also requires an update value. These are three bits wide (enabling support for eight-state logic). Therefore messages sent from processor to processor will need to be eighteen bits wide. These figures are arbitrary but are a useful starting point.

The structure of a cell 21 is shown in FIG. 9. Each of the four edges has a transmitter 25 and a receiver 26. These modules deal with the serial connections. The transmitter 25 takes in an eighteen-bit entity and sends it out in a bit stream. The receiver 26 takes in the bit stream and reconstitutes it into the original eighteen-bit message.

A request scanner 27 checks every receiver 26 and the APPLES processor 30 simultaneously to see if they have messages waiting to be routed. It assigns each of these sources a rotating priority and picks the source that has a message and the highest priority. It then passes the picked message to a request router 28.

The request router 28 passes its messages either to the APPLES processor 30 or to a transmitter 25. If the option chosen is a transmitter then the message will be sent to a different cell 21. If the option chosen is the APPLES processor 30 then the message is an update for the local processor. A synchronisation logic circuit 31 controls the cell 21 through the synchronisation logic circuit 22.

In FIG. 9 every transmitter, every receiver and the input and output ports of the APPLES processor have buffers connected. A command line parameter to the Verilog compiler specifies whether these components are to be used or removed from the design. One slightly different behaviour of these buffers is that they process data in a LIFO fashion. The effect of these buffers on performance is an important part of the system analysis.

The request router 28 employs one of two different routing techniques. The technique used is determined by a command line parameter to the Verilog simulator used to implement the invention. A comparison of the routing techniques is important to the understanding of the invention. Both routing techniques operate in a similar manner.

The request router 28 decodes the message. It can then determine the destination processor. It determines all the valid options for routing the message. The message could be routed to the local APPLES processor 30 or to one of the transmitters 25. The message is then routed to one of the valid options.

The first routing technique only produces one valid routing option and if that route is not blocked then the message is routed in that direction. If it is blocked then the request router 28 attempts to route a different message. Messages are passed from cell 21 to cell 21 until they reach their destination. Under this routing technique a message is passed first either in the east or west direction until it is at the correct east-west location. It is then routed in the north or south direction until the message arrives at its destination. The net result of the message passing is that the message travels the minimum distance. This routing strategy results in the traffic between any two given cells 21 always following the same route through the network. This routing strategy can be called standard routing.

The second routing technique is more complicated. Under this strategy the request router 28 determines all of the available directions that can be taken by the message which will result in it travelling the shortest distance. The various options have different priorities associated with them. This priority is based on the options that were previously taken. This priority method helps to use the various routes evenly and therefore efficiently. Some of the options may not be feasible as they may be in use with previous messages. An option is chosen based on priority and availability. The priority information is then updated. This routing strategy is an advanced routing.

For both routing techniques, when all valid paths are blocked and the request router 28 is unable to route its message then it simply drops the message. This is an important aspect to the manner in which the request scanner 27 and request router 28 work together. The request scanner 27 takes a message from one of its sources. It does not inform the source that it is attempting to route this message.

The source maintains the message at its output. If the request router 28, successfully routs the message then it tells request scanner 27 that it has done so and the request scanner 27 informs the source. This way the request router 28 is not committed to routing a particular message. The request router 28 therefore is always free to attempt to route messages.

The network interface 42 shares access to the input value register bank 20 between the local processor and the network. The local processor gets priority. This module decodes the message and updates the appropriate location in the input value register bank 2.

The network interface 42 is connected between the fan out generator 43 and the I Input value register bank 2. It can therefore pass fan out updates from the processor to the network when appropriate or simply pass them to the input value register bank 2. It can also pass fan out updates from the network to the input value register bank 2. Some changes were required in the fan out generator 43 to accommodate the network interface 42.

When each processor in the array has processed the fan out list for each of its active gates and all updates have reached their destination then each processor can shift its input value register bank 2 into its array 1b and proceed with evaluation of the next time unit. In order to achieve this some synchronisation logic, between the cells 21, is required. The implementation for this requires each processor to report to its cell 21 when it has completed sending updates. Each cell 21 also monitors the network activity and reports back to the array stating whether there is network activity or processor activity. The array therefore knows when all processors are finished updating and when the network is empty. At such a time the array reports back to the cells 21. Then the cells 21 tell the processors to proceed with the next time unit in the delay model. The implementation of this system required minor changes in the sequence logic of the APPLES processor.

The network is not used to communicate this synchronisation information. Instead dedicated wires are provided. Each cell 21 has a finished input wire and a finished output wire. The cell 21 holds the finished output wire high when its processor has finished and no network activity is occurring around the cell 21. The finished input wire is controlled by the array synchronisation logic. The array holds it high when it detects that all the finished output wires are high at the same time. It would be possible to use the network to communicate this synchronisation information. This would reduce the number of Virtex pins required by the design. However the synchronisation logic would be more complex and require more circuitry. The synchronisation process would also take longer to execute.

The information pertaining to the circuit description is stored in five memories within an APPLES processor. Under the basic APPLES Verilog design these memories are loaded from data files using the $READMEM system command. For the system to be implemented on a Virtex chip these memories could be loaded via a PCI interface.

Under the APPLES array each processor evaluates part of the circuit to be simulated. The contents of these five memories need to be split among the processors in the array. The memory contents also need to be processed in order to make it compatible with the array design. Under an implementation using an array of Virtex chips this data could be loaded via a PCI bus and distributed using the array network. The data would be pre-processed for the array and each processor would simply need to load the data into its memories. The incorporation into the design of a system to distribute this data is non-trivial. This project is mainly concerned with the analysis of the array design's ability to simulate circuits. An analysis of the array's initialisation system is not of paramount importance at this time. As a result the initialisation system was not designed.

In order to initialise the design, to facilitate simulating circuits, a Verilog task was written to load the memories. The single processor circuit description files are loaded into a global memory in the design. Each processor in the array is assigned a number. A processor's number is calculated by multiplying its y co-ordinates by the array width and adding its x co-ordinates. Each processor loads a segment of the global Array 1a, Array 1b, the fan out header table and the fan out size table into its local memory. These segments are of equal size. The segments chosen are based on their processor number. Processor zero takes the first segment, processor one takes the second segment and so on. A segment of the fan out vector table must be loaded also. The segment is determined by looking at the contents of the local fan out size and fan out header tables. The first address to be loaded from the global fan out vector table is the address stored in the first location in the local fan out header table. The last address to be loaded is calculated by adding the address stored in the last entry in the local fan out header table to the last fan out size stored in the final entry in the local fan out size table. The addresses within the fan out header table must be adjusted to point at the new local fan out vector table. This is achieved by subtracting the address stored in the first location in the local fan out header table from each address in the same table. Each gate input address stored in the local fan out vector table must be converted into an array address. An array address consists of the destination processor's x co-ordinates stored in bits fourteen to twelve, the destination processor's y co-ordinates stored in bits eleven to nine and the gate input's local address on the destination processor stored in bits eight to ten.

Using this system the circuit description is split among the processors. No consideration is given to decide which gate is simulated on which processor. The APPLES circuit description files determine where each gate is simulated. The layout of these files is determined by the layout of the iscas-85 net list files that were used to generate the APPLES circuit description files.

Referring to FIG. 10, there is illustrated an alternative layout of processor in which parts similar to those described with reference to FIG. 1 are identified by the same reference numerals. In this embodiment, the scan registers are identified by the reference numerals 6a and the general logic sequence is identified by the reference numeral 40. The processor will also include a circuit splitting logic circuit 41 and a network interface 42. A fan out generator 43 is identified and will include, for example, the fan out memory 8. The network interface 42 shares access to the input value register bank 2.

The original APPLES design is written in Verilog. So is the array design. The Verilog code is written at a behavioural level. This is the most abstract level available to a Verilog programmer. As with any Verilog system it is split into Verilog modules. Each module is a component of the system. The Verilog modules added under the APPLES array design are:
The Top Module
The Array Module
The Cell Module
The Receiver Module
The Transmitter Module
The Request Scanner Module
The Request Router Module
The Buffer Module
The Network Interface Module

The Top module is used to test that the system is performing correctly. An instantation of the Top module contains an instantiation of the array module. The array contains multiple instantiations of the Cell module. Each Cell contains four instantiations of both the transmitter and Receiver modules. A Cell also contains a Request Scanner, a Request Router, several buffers and an APPLES processor. The APPLES processor contains instantiations of the standard processor components along with an instantiation of the Network Interface module. This structure and the behaviour of these modules were described earlier in this chapter. Each of these modules is contained within an appropriately named file.

In addition to designing these modules the array design also required the following changes:
The introduction of a Verilog task to split the circuit description information among the processors in the array. This is located in the APPLES processor module.
The incorporation of processor synchronisation logic into the APPLES processor module, the Cell module and the Array module.
The integration of the Network Interface module into the APPLES processor.

The APPLES architecture incorporates an alternative timing strategy which obviates the need for complex deadlock avoidance or recovery procedures and other mechanisms normally part of an event-driven simulation. The present invention has an overhead which is considerably less than conventional approaches and permits gate evaluation to be activated in memory. The reduction in processing overheads is manifest in improved speedup performance relative to other techniques.

A message passing mechanism inherent in the Chady-Misra algorithms has been replaced by a parallel scanning mechanism. This mechanism allows the fan-out/update procedure to be parallelised. As clashes occur gates are effectively put into a waiting queue which fills up an fan-out update pipeline. Consequently as the pipeline fills up (with the increase number of scan registers), performance increases. The speedup reaches a limit when the new gates entering the queue equals the fan-out rate. Nevertheless, the speedup and the number of cycles per gate processed is considerably better than conventional approaches. The system also allows a wide range of delay models.

The bit-pattern gate evaluation mechanism in APPLES facilitates the implementation of simple and complex delay models as a series of parallel searches. Consequently, the evaluation process is constant in time, being performed in memory. Effectively, there is a one to one correspondence between gate and processor (the gate word pairs). This fine grain parallelism allows maximum parallelism in the gate evaluation phase. Active gates are automatically identified and their fan-out lists updated through scanning a hit-list. This scanning mechanism is analogous to Communication overhead in typical parallel processing architectures, however, this scanning is amenable to parallelisation itself. Multiple scan-registers reduce the overhead time and enable the gate processing rate to be limited solely by the fan-out memory bandwidth. The substantial speedup of the logical simulation with the APPLES architecture is attained resulting in a gate processing rate of a few machine cycles.

In this specification, the terms “comprise”, “comprises” and “comprising” are used interchangeably with the terms “include”, “includes” and “including”, and are to be afforded the widest possible interpretation and vice versa.

The invention is not limited to the embodiments hereinbefore described which may be varied in both construction and detail within the scope of the claims.

1. A computer implemented parallel processing method for performing a logic simulation, comprising:
representing signals on a line over a time period as a bit sequence;
evaluating gate outputs of logic gates including an evaluation of any inherent delay by comparing bit sequences of inputs of the logic gates to a predetermined series of bit patterns and in which logic gates whose outputs have changed over the time period are identified during the evaluation of the gate outputs as real gate changes and only the logic gates having the real gate changes are propagated to respective fan out gates of the logic gates having the real gate changes;
storing in word form in an associative memory mechanism a history of gate input signals by compiling a hit list register of logic gate state changes;
generating an address for each hit in the hit list via a multiple response resolver forming a part of the associative memory mechanism, and then scanning and transferring results on the hit list to an output register for subsequent use; and
dividing an associative register into separate smaller associative sub-registers, allocating one type of logic gate to each associative sub-register, each of which associative sub-registers has corresponding sub-registers connected thereto, and carrying out gate evaluations and tests in parallel on each associative sub-register.

2. The method as claimed in claim 1, further comprising storing each delay as a delay word in the associative register
wherein the storing step comprises the steps of:
determining a length of the delay word; and
if the length of the delay word exceeds a register word length of the associative register word calculating a number of integer multiples of the register word length contained within the delay word as a gate state, storing the gate state in a state register and storing a remainder from the calculation in the associative register with the delay words whose lengths did not exceed the register word length, and
wherein when a count of the associative register commences:
the state register is consulted for the delay word entered in the state register and the remainder is ignored for the respective count of the associative register;
at the end of the count of the associative register, the state register is updated; and
the count continues until the remainder represents that the count is still required.

3. The method as claimed in claim 1, further comprising:
segmenting the hit list into a plurality of separate smaller hit lists, each smaller hit list being connected to a separate scan register; and
transmitting in parallel results of each scan register to the output register.

4. The method as claimed in claim 1, further comprising storing each line signal to a target logic gate as a plurality of bits each representing a delay of one time period,
wherein aggregate bits representing a delay between a signal output to and reception by the target logic gate, and in which the inherent delay of each logic gate is represented in the same manner.

5. The method as claimed in claim 1, further comprising using each associative sub-register to form a hit list connected to a corresponding separate scan register.

6. The method as claimed in claim 1, further comprising using more than one associative sub-register when a umber of one type of logic gate exceeds a predetermined number.

7. The method as claimed in claim 3, further comprising controlling the scan registers by exception logic using an OR gate whereby the scan is terminated for each register on the OR gate changing a state thus indicating no further matches.

8. The method as claimed in claim 8, wherein the scan is carried out by sequentially counting through the hit list and performing the steps of:
checking if the bit is set indicating a hit;
if a hit, determining the address effected by that hit;
storing the address of the hit;
clearing the bit in the hit list;
moving to a next position in the hit list; and
repeating the above steps until the hit list is cleared.

9. The method as claimed in claim 1, further comprising storing each line signal to a target logic gate as a plurality of bits each representing a delay of one time period,
wherein aggregate bits represent the delay between a signal output to and reception by the target logic gate.

10. The method as claimed in claim 1, further comprising performing is an initialization phase, in which includes the steps of:
inputting specified signal values to an input circuit including the logic gates;
setting unspecified signal values to unknown;
preparing test templates to define a delay model for each logic gate;
parsing the input circuit to generate an equivalent circuit including 2-input logic gates; and
configuring the 2-input logic gates

11. The method as claimed in claim 1, further comprising applying a multi-valued logic in which n bits are used to represent a signal value at any instance in time with n being any arbitrarily chosen logic.

12. The method as claimed in claim 11, wherein the multi-value logic includes an 8-valued logic, where 000 represents logic 0, 111 represents logic 1 and 001 to 110 represents other arbitrarily defined signal states.

13. The method as claimed in claim 11, further comprising storing a sequence of values on a logic gate as a bit pattern forming a unique word in the associative memory mechanism.

14. The method as claimed in claim 1, further comprising storing a record of all values that a logic gate has acquired for units of delay a longest delay in the circuit.

15. A parallel processor for a logic event simulation (APPLES) comprising:
a main processor;
an associative memory mechanism including a response resolver;
wherein the associative memory mechanism further comprises:
a plurality of separate associative sub-registers each for storing in word form of a history of gate input signals for a specified type of logic gate; and
a plurality of separate additional sub-registers associated with each associative sub-register whereby gate evaluations and tests can be carried out in parallel on each associative sub-register.

16. The processor as claimed in claim 15, wherein the additional sub-registers comprise an input sub-register, a mask sub-register and a scan sub-register.

17. The processor as claimed in claim 16, wherein the scan sub-registers are connected to an output register.
